(19) United States
(12) Patent Application Publication
(10) Pub. No.: US 2024/0041064 A1
(43) Pub. Date: Feb. 8, 2024

(54) PROTEIN CONCENTRATE AND METHOD OF PREPARATION

(71) Applicant: UMARO FOODS, INC., Albany, CA (US)

(72) Inventors: Beth Alison Zotter, Albany, CA (US); Amanda Stiles, Albany, CA (US)

(21) Appl. No.: 18/259,815

(22) PCT Filed: Dec. 29, 2021
(86) PCT No.: PCT/US2021/065591

§ 371 Date: Jun. 29, 2023

Related U.S. Application Data
(60) Provisional application No. 63/133,172, filed on Dec. 31, 2020.
(60) Provisional application No. 63/133,177, filed on Dec. 31, 2020.

(51) Int. Cl. A23J 1/00; A23J 3/14; A23J 3/22; A23L 17/60; A23J 3/34

(52) U.S. Cl. CPC A23J 1/006; A23J 3/14; A23J 3/227; A23L 17/60; A23J 3/346

(57) ABSTRACT

Embodiments include a method of producing a protein concentrate from seaweed for use as a meat substitute. The seaweed protein concentrate can be seasoned and/or colored for use as a meat substitute or other protein-based product.

### FIELD OF THE INVENTION

The invention relates to protein concentrates that can also function as meat substitutes for human consumption, and more specifically, to methods and compositions for the production of consumables that are sourced from seaweed and/or other plant source.

### BACKGROUND

Meat is an important source of nutrition for many people around the world and global demand for meat is growing. Per capita meat consumption has increased approximately 20 kilograms since 1961. Worldwide, the average person consumed around 43 kilograms of meat in 2014; the average American consumed over 100 kilograms of meat. Over the past 50 years, meat production has more than quadrupled. The world now produces more than 320 million tons each year. This increase in per capita meat trends means total meat production has been growing at a much faster than the rate of population growth.

Intensive animal farming or industrial livestock production, also known as factory farming, is a type of intensive agriculture, specifically an approach to animal husbandry designed to maximize production, while minimizing costs. To achieve this, agribusinesses keep livestock such as cattle, poultry, and fish at high stocking densities, at large scale, and using modern machinery, biotechnology, and global trade. The mass production and consumption of meat has been determined to pose risks for human health and the environment. Efforts have been made to produce meat substitutes to address ethical, health and environmental concerns.

For example, vegetarian (i.e. non-meat) burger patties have been marketed in grocery stores and restaurants with marginal success. The patties are usually made from isolated components of plants and/or soybeans (i.e. bean curd or tofu). However, these meat substitutes have largely failed to shift consumers toward a vegetarian diet. The current state of the art for meat substitute compositions involves the extrusion of a soy/grain mixture, resulting in products that largely fail to replicate the experience of cooking and eating meat. For example, the texture and mouthfeel of these products are more homogenous than that of meat products. Further, as the products must largely be sold pre-cooked, with artificial flavors and aromas built in, they fail to replicate aromas, flavors, and other key features associated with cooking meat. As a result, these products appeal mainly to a limited consumer base that is already committed to vegetarianism. They typically do not appeal to the bulk of consumers who are accustomed to eating meat.

Inevitably the demand for protein will continue to grow, particularly within developed countries. Intensive animal farming presents risks to human health and the environment. There is therefore a need to develop improved meat substitutes using plant proteins. Accordingly, there is a need for robust methods for the extraction of proteins from alternative sources that have a lower ecological impact than those currently used in farming and food processing.

Seaweed is often used as a general term to describe several different species of algae and marine plants. Edible seaweed is classified by color. The most commonly eaten types are red, green and brown. Seaweed is well established as a source of thickeners and emulsifiers such as carrageenan and agar. One advantage of using seaweed as a protein source is the reduction of burden on the environment. Seaweed cultivation does not rely on land, synthetic fertilizers or fresh water to produce proteinaceous biomass. Instead, seaweed grows in saltwater, and uses inorganic nutrients, for example nitrate, that naturally flow through the water column. Moreover, the protein yield in tons per hectare per year (ton/ha/yr) for macroalgae is in the range of 2.5-7.5. This value is two to five times higher than that of wheat or legumes. Seaweed can also be harvested throughout the year and some species contain all the essential amino acids required for human nutrition. Attempts at formulating meat substitutes derived from seaweed have been largely unsuccessful in replicating the sensory attributes, nutritional profile, and taste of animal meat.

Past efforts to produce food products from seaweed have had limited success. Seaweed tends to impart an unpleasant fishy or marine flavor. Moreover, such meat substitutes and related products typically have a texture and mouthfeel that are dissimilar to animal meat products. Accordingly, there is an unmet need for a meat substitutes made from concentrated seaweed proteins, as well as methods to produce such products.

Additionally, other plant sources can be used to derive protein concentrates, including as a substitute for other commonly consumed animal proteins, for example, whey protein derived from the milk of an animal, such as a cow or goat.

A meat substitute derived from a plant or non-animal material, including, a meat substitute containing a seaweed protein concentrate, can present health benefits to the consumer while curbing the environmental impacts of factory farming. It should also exhibit flavors and textures to satisfy cravings of meat eaters and shift them toward a vegetarian diet without sacrificing the sensory pleasure and satisfaction of eating animal meat. There is also a need for methods to efficiently produce food products from seaweed on a large scale, in particular food products that are tasty and nutritious. The present invention meets these and other needs.

Known challenges to extraction of protein from seaweed include ionic interactions with polysaccharides, high cell wall strength, and high viscosity. The cell wall accounts for up to 65% by weight of dry matter, comprising the fibrillar wall, amorphous matrix and the glycoprotein domain. Known challenges to extraction of protein from seaweed include ionic interactions with polysaccharides, high cell wall strength, and high viscosity. Common seaweed polysaccharides, e.g. alginate and carrageenan, are used as gels and food additives specifically because they bond well to protein. This feature presents an additional difficulty in the purposeful separation and extraction of protein bound up with hydrocolloids present in the raw material.

One method to release proteins from hydrocolloids is to employ polysaccharide-degrading enzymes, however enzymatic digestion is time-consuming and often economically unviable. Furthermore, seaweed hydrocolloids are highly valuable. The ideal protein extraction process will preserve polysaccharides in the process of extracting protein to maximize the economic value of both protein and polysaccharide fractions. The invention described uses methods to extract and concentrate protein from seaweeds that provide an economically viable and scalable approach to produce seaweed protein concentrate. The three primary seaweed hydrocolloids used in industry are agar, carrageenan, and alginate.

Agar is a hydrocolloid commonly found in red seaweeds such as Gracilaria and Gelidium, and consists of a mixture of agarose and agaropectin, with agarose representing the majority of the composition. Agarose is a linear polymer formed by repeating units of agarobiose. Agaropectin is a sulfated polysaccharide made up of alternating units of D-galactose and L-galactose characterized by acidic side-groups, such as sulfate and pyruvate. Agar is widely used as a gelling agent in the food industry, and agarose is commonly used for bacteriological culture.

Carrageenan is a hydrocolloid sourced from red seaweeds including Eucheuma, Kappaphycus, Chondrus, and Gigartina. Carrageenan is formed by alternating units of D-galactose and 3.6 anhydro-galactose. Carrageenan can be classified by chemistry and structure. The kappa, iota and lambda carrageenan types are determined by the number and position of ester sulfate groups as well as the content of 3.6-AG. Kappa and iota types are gelling, while lambda carrageenan is a non-gelling type used in industry to increase viscosity. Carrageenan is commonly used in beverage formulations to stabilize proteins and prevent them from precipitating out of solution.

Alginate is a hydrocolloid found in brown seaweeds such as Saccharina, Macrocystis, and Undaria. Alginate is a block copolymer composed of blocks of β-D-mannuronate (M blocks) and a-L-guluronate (G blocks) in various sequences. The gel strength of the hydrocolloid is highly influenced by the ratio of M and G blocks, with high G content corresponding to high gel strength. Alginate forms gels in the presence of divalent cations, e.g. calcium and magnesium ions. It is often sold in the form of its sodium salt, sodium alginate.

The present invention provides improved methods for the isolation of proteins from a plant, including a seaweed.

### SUMMARY OF THE INVENTION

The following summary is provided to facilitate an understanding of some of the innovative features unique to the disclosed embodiment and is not intended to be a full description. A full appreciation of the various aspects of the embodiments disclosed herein can be gained by taking into consideration the entire specification, claims and abstract as a whole.

The present invention relates to methods for extraction, purification, and/or concentration of proteins from seaweed in order to produce a product appropriate for application in the formulation of plant-based meat, egg, or dairy substitutes. The invention overcomes some of the disadvantages found when using current manufacturing techniques to isolate proteins from grains (including, quinoa, barley, bulgur, farro and kasha), pulse (including, lentils, dry beans, dry broad beans, dry peas, chickpeas, cow peas, pigeon peas, Bambara beans, vetches, lupins, pulses nes), cereals (including, pearl millet, proso millet, sorghum, oats, rye, tell, triticale, linger millet, fonio, foxtaii millet, kodo millet, Japanese millet, Job's Tears), pseudograiris (including, amaranth, breadnut, buckwheat, chic, cockscomb, pitseed goosefoot, kaniwa, wattleseed) legumes (including, alfalfa, clover, peas, beans, lupins, mesquite, carob, soybeans, peanuts, tamarind), rice, mung beans, corn or wheat based protein concentrates to create a plant-based meat, egg, or dairy like product by using, in an embodiment, a seaweed extract, including a seaweed protein concentrate, which provides improved taste, texture and/or color.

Embodiments include a protein concentrate sourced from seaweed for use as a meat substitute. The concentrate can include components of the seaweed that are beneficial for health, flavor, texture, color, etc.

Embodiments include a meat substitute for use in applications such as meat and seafood alternatives in snack and protein bars/supplements.

Embodiments include methods of producing a meat substitute sourced from seaweed.

Embodiments also include meat substitutes and related products that have textures similar to meat products. Further, embodiments include meat substitutes with aromas, flavors, and other features that mimic meat.

Embodiments include a method of producing protein concentrate from seaweed. The method can include steps of (a) particle size reduction of dry or fresh seaweed, (b) extraction of a protein component from the starting material by solubilization in an aqueous solution, (c) a first separation of the insoluble components from the soluble components, (d) precipitation of soluble protein to yield insoluble protein, (e) a second separation of insoluble components from the soluble components to yield a solid fraction containing protein, and (l drying the solid fraction to yield a protein concentrate.

Embodiments include an alternative method of producing a protein concentrate from seaweed by the physical separation of seaweed structural components. The method can include steps of (a) particle size reduction of dry or fresh seaweed, (b) application of heat and acid (c) a separation of the protein-rich components from other components, (d) a recycle step, and (e) drying the protein-rich component to yield a protein concentrate.

The starting material can be fresh seaweed or dried seaweed. The seaweed can be red seaweed, brown seaweed, a green seaweed, and/or a combination of seaweed types.

In an embodiment, the starting material is a mixture of seaweed and other plants, including microorganisms.

The step of particle size reduction includes homogenization, for example by milling or maceration. The particle size reduction can include milling of dry material. The particle size reduction step can also include resuspension of material in an aqueous solution followed by maceration.

The step of extraction can include mixing, dilution, enzymatic digestion, high pressure processing and/or sonication.

The step of separation may include separation of soluble and insoluble components by centrifugation or filtration. Types of centrifuges include decanting, disc stack, hydrocyclone, basket, dead end, and vertical tubular configurations.

The step of precipitation may include lowering the pH of the separated soluble fraction using a food grade acid. The step of precipitation may form a solid or semi-solid fraction containing insoluble protein. Precipitation may include a heating step or a freezing step. In an embodiment, the addition of a heating or freezing step increases the amount of protein in the precipitated fraction.

In an embodiment, the protein concentrate can be collected through column chromatography.

The second separation step may include separation of soluble and insoluble components by centrifugation or filtration. The insoluble component may be resuspended in an aqueous solution and separated in the same manner in a repeated fashion. In an embodiment, the repeated separation improves the functionality of the protein fraction, e.g. taste, solubility, color, odor, etc. In another embodiment, the repeated separation step increases the protein content of the resulting protein concentrate.

In an embodiment of the second separation step, a polar solvent is used. In an embodiment, the polar solvent is an alcohol. In an embodiment, the polar solvent improves the functionality of the resulting protein concentrate.

The drying step may include drying by drum drying, spray drying, freeze drying, infrared drying, or oven drying. In an embodiment, the pH is adjusted before or during the drying process to improve the functionality of the resulting protein concentrate, e.g. taste, solubility, color, odor, etc.

In an embodiment, a sediment is a solid or semi-solid formed in a solution following precipitation or centrifugation.

One or more flavor enhancers can be added to the protein concentrate during or after any of the aforementioned steps.

In an embodiment, the protein concentrate can be at least 1%, at least 5%, at least 10%, at least 15%, at least 20%, at least 25%, at least 30%, at least 35%, at least 40%, at least 45%, at least 50%, at least 55%, at least at least 60%, at least 65%, at least 70%, at least 75%, at least 80%, at least 85%, at least 90% or at least 95% protein by weight.

Another embodiment is a method of producing a protein concentrate from seaweed with a wafer-like structure that includes a step precipitating seaweed protein from solution at a pH of about pH 2.5 and freezing the seaweed protein concentrate to create a fibrous solid mass. In an embodiment, the fibrous solid mass is structured to resemble an animal meat product.

Another embodiment is a method of producing a protein concentrate from seaweed with a fibrous structure that includes neutralizing the pH of a seaweed protein concentrate and freeze drying the seaweed protein concentrate to create a fibrous solid mass. In an embodiment, the fibrous solid mass produced is structured to resemble an animal meat product.

### BRIEF DESCRIPTION OF THE FIGURES

FIG. 1 is a flowchart that depicts a process of producing a protein concentrate according to an embodiment.

FIG. 2 is a flowchart that depicts a process of producing a protein concentrate according to an embodiment.

FIG. 3 is a flowchart that depicts a process of producing a protein concentrate according to an embodiment.

FIG. 4 is a Particle Size Distribution Result Analysis Report of the dried seaweed after the particle size had been reduced using a hammer mill of Example 4.

FIG. 5 is a Particle Size Distribution Result Analysis Report of the protein concentrate of Example 4.

FIG. 6 is a flowchart that depicts a process of producing a protein concentrate of Example 5.

FIG. 7 is a photo of the Gracilaria of Example 3 after agitation showing partially delaminated pieces.

FIG. 8 is a photo of the collected outer cortex layers of the Gracilaria seaweed of Example 3 after separation from the inner core material. The outer cortex is rich in the red colored protein phycoerythrin.

FIG. 9 is a photo of the inner core material of the Gracilaria seaweed of Example 3 after separation from the outer cortex. The inner core is rich in the carbohydrate agar.

FIG. 10 is a photo showing the fibrous structure of seaweed protein concentrate after freeze drying.

FIG. 11 is a photo showing previously frozen seaweed protein concentrate suspended in 95% ethanol.

FIG. 12 is the PDCAAS Analysis Report of the protein concentrate generated in Example 4.

### DEFINITIONS

Reference in this specification to “one embodiment/aspect” or “an embodiment/aspect” means that a particular feature, structure, or characteristic described in connection with the embodiment/aspect is included in at least one embodiment/aspect of the disclosure. The use of the phrase “in one embodiment/aspect” or “in another embodiment/aspect” in various places in the specification are not necessarily all referring to the same embodiment/aspect, nor are separate or alternative embodiments/aspects mutually exclusive of other embodiments/aspects. Moreover, various features are described which may be exhibited by some embodiments/aspects and not by others. Similarly, various requirements are described which may be requirements for some embodiments/aspects but no other embodiments/aspects. Embodiment and aspect can be in certain instances be used interchangeably.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. It will be appreciated that the same thing can be said in more than one way.

Consequently, alternative language and synonyms may be used for any one or more of the terms discussed herein. Nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any exemplified term. Likewise, the disclosure is not limited to various embodiments given in this specification.

Without intent to further limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions, will control.

All numerical designations, e.g., pH, temperature, time, concentration, and molecular weight, including ranges, are to be understood as approximations in accordance with common practice in the art. When used herein, the term “about” may connote variation (+) or (−) 1%, 5% or 10% of the stated amount, as appropriate given the context. It is to be understood, although not always explicitly stated, that the reagents described herein are merely exemplary and that equivalents of such are known in the art.

“Dry weight” and “dry cell weight” mean weight determined in the relative absence of water. For example, reference to macroalgae and/or microalgae biomass as comprising a specified percentage of a particular component by dry weight means that the percentage is calculated based on the weight of the biomass after substantially all of the water has been removed.

The term “seaweed protein concentrate” means a concentrated fraction of protein that is derived from a seaweed and is higher in protein content on a dry weight basis than the seaweed or seaweeds used as the starting material.

The term “seaweed,” “edible seaweed,” or “sea vegetable” refers to seaweeds that can be eaten and used in the preparation of food. They may belong to one of several groups of multicellular algae: the red algae, green algae, and brown algae. Seaweed can be classified into three distinct Phyla based on their pigmentation: brown seaweeds (Phylum Phaeophyta), green seaweeds (Phylum Chlorophyta) and red seaweeds (Phylum Rhodophyta). Common types of seaweed include nori (a red seaweed commonly sold in dried sheets and used to roll sushi), sea lettuce (a type of green seaweed that looks like lettuce leaves that is often eaten raw in salads or cooked in soups), aonori (a type of green seaweed), kombu (a type of brown seaweed with a strong flavor that is often pickled or used to make soup stock), arame (a type of brown seaweed with a mild, sweet flavor and firm texture), wakame (a brown seaweed commonly used to make seaweed salad, stews and soups), and dulse (a red seaweed with a soft, chewy texture and has a taste similar to bacon when fried). Kelp is a type of brown seaweed in the order Laminariales.

In an embodiment, some of the components of seaweeds of interest include agar and carrageenan (hydrocolloid gels that are often used as plant-based binding and thickening agents). Other components of seaweeds of interest include hemicellulose, alginic acid, fucoidan, polyphenols, sulfated polysaccharides, mucilage, micosporine-like amino acids, iodine, other minerals, and bioactive organic compounds.

The term “modified plant source” as used herein refers to a plant that is altered from its native state through some form of modification to create a plant with an enhanced characteristic. The modification can occur through mutation or genetic engineering of the plant nucleotide sequence. The modification can also occur through the creation of hybrids by grafting and other methods.

The term “animal meat” as used herein refers to flesh, whole meat muscle, muscle tissue derived from animal cell culture, organs or any parts thereof that are derived from an animal. An animal can include a cow, a sheep, a pig, a goat, a bird, a fish, a shellfish (including a scallop, a clam, an oyster), a crustacean (including a crab, a lobster), a duck, an emu and ostrich, or any other species commonly understood to comprise a source of meat that is used for consumption by another animal, including a human.

The term “natural” or “naturally occurring” as used herein refers to what is found in nature.

The term “shelf life” refers to the length of time that consumables are given before they are considered unsuitable for sale, use, or consumption. Generally, it is important to maintain a meat product at about 2° C. as the shelf life decreases with exposure to higher temperatures.

The terms “optional” or “optionally” mean that the feature or structure may or may not be present, or that an event or circumstance may or may not occur, and that the description includes instances where a particular feature or structure is present and instances where the particular feature or structure is absent, or instances where the event or circumstance occurs and instances where the event or circumstance does not occur.

The terms “polypeptide,” “peptide” and “protein” are used interchangeably herein to refer to a polymer of amino acid residues. The terms apply to amino acid polymers in which one or more amino acid residue is an artificial chemical mimetic of a corresponding naturally occurring amino acid, as well as to naturally occurring amino acid polymers and non-naturally occurring amino acid polymer. Methods for obtaining (e.g., producing, isolating, purifying, synthesizing, and recombinantly manufacturing) polypeptides are well known to one of ordinary skill in the art.

The term “Protein hydrolysis” refers to a process of digesting or breaking up proteins usually at specific peptide cleavage bonds, which results in digestion consisting of amino acids and peptides of varying size. It can be carried out by chemical and enzymatic methods.

The term “xylanase” refers to a class of enzymes that degrade the linear polysaccharide xylan into xylose, thus breaking down hemicellulose, one of the major components of plant cell walls. As such, it plays a major role in micro-organisms thriving on plant sources for the degradation of plant matter into usable nutrients.

The term “cellulase” refers to any of several enzymes produced chiefly by fungi, bacteria, and protozoans that catalyze cellulolysis, the decomposition of cellulose and of some related polysaccharides.

The term “amino acid” refers to naturally occurring and synthetic amino acids, as well as amino acid analogs and amino acid mimetics that function in a manner similar to the naturally occurring amino acids. Naturally occurring amino acids are those encoded by the genetic code, as well as those amino acids that are later modified, e.g., hydroxyproline, gamma-carboxyglutamate, and O-phosphoserine. Amino acid analogs refer to compounds that have the same basic chemical structure as a naturally occurring amino acid, i.e., a carbon that is bound to a hydrogen, a carboxyl group, an amino group, and an R group, e.g., homoserine, norleucine, methionine sulfoxide, methionine methyl sulfonium. Such analogs have modified R groups (e.g., norleucine) or modified peptide backbones, but retain the same basic chemical structure as a naturally occurring amino acid Amino acid mimetics refers to chemical compounds that have a structure that is different from the general chemical structure of an amino acid, but that functions in a manner similar to a naturally occurring amino acid.

Amino acids may be referred to herein by either their commonly known three letter symbols or by the one-letter symbols recommended by the IUPAC-IUB Biochemical Nomenclature Commission. Nucleotides, likewise, may be referred to by their commonly accepted single-letter codes.

An amino acid and derivatives thereof can include cysteine, cystine, a cysteine sulfoxide, allicin, selenocysteine, methionine, isoleucine, leucine, lysine, phenylalanine, threonine, tryptophan, 5-hydroxytryptophan, valine, arginine, histidine, alanine, asparagine, aspartate, glutamate, glutamine, glycine, proline, serine, tyrosine, ornithine, carnosine, citrulline, carnitine, ornithine, theanine, and taurine.

“Good manufacturing practice” and “GMP” mean those conditions set by the standards set out in standard 21 CFR 110 (for human consumption) and 111 (for dietary supplements), or comparable regulatory schemes established in locations outside the United States. US regulations are enacted by the United States Food and Drug Administration under the authority of the Federal Food, Drug, and Cosmetic Act and to regulate the manufacturers, processors, and packers of food products and dietary supplements for human consumption.

The term “umami” or “savoriness” refers to one of the five basic tastes. It can be described as savory and is characteristic of broths and cooked meats.

The present composition encompasses amino acid substitutions in proteins and peptides, which do not generally alter the activity of the proteins or peptides (H. Neurath, R. L. Hill, The Proteins, Academic Press, New York, 1979). In one embodiment, these substitutions are “conservative” amino acid substitutions. The most commonly occurring substitutions are Ala/Ser, Val/Ile, Asp/Glu, Thr/Ser, Ala/Gly, Ala/Thr, Ser/Asn, Ala/Val, Ser/Gly, Ala/Pro, Lys/Arg, Asp/Asn, Leu/Ile, Leu/Val, Ala/Glu and Asp/Gly, in both directions.

As to “conservatively modified variants” of amino acid sequences, one of skill will recognize that individual substitutions, deletions or additions to a nucleic acid, peptide, polypeptide, or protein sequence which alters, adds or deletes a single amino acid or a small percentage of amino acids in the encoded sequence is a “conservatively modified variant” where the alteration results in the substitution of an amino acid with a chemically similar amino acid. Conservative substitution tables providing functionally similar amino acids are well known in the art. Such conservatively modified variants are in addition to and do not exclude polymorphic variants, interspecies homologs, and alleles of the invention.

The following eight groups each contain amino acids that are conservative substitutions for one another: 1) Alanine (A), Glycine (G); 2) Aspartic acid (D), Glutamic acid (E); 3) Asparagine (N), Glutamine (Q); 4) Arginine (R), Lysine (K); 5) Isoleucine (I), Leucine (L), Methionine (M), Valine (V); 6) Phenylalanine (F), Tyrosine (Y), Tryptophan (N); 7) Serine (S), Threonine (T); and 8) Cysteine (C), Methionine (M) (see, e.g., Creighton, Proteins (1984)).

Analogue as used herein denotes a peptide, polypeptide, or protein sequence which differs from a reference peptide, polypeptide, or protein sequence. Such differences may be the addition, deletion, or substitution of amino acids, phosphorylation, sulfation, acrylation, glycosylation, methylation, farnesylation, acetylation, amidation, and the like, the use of non-natural amino acid structures, or other such modifications as known in the art.

The term “protein concentrate” as used herein refers to a product prepared by extracting proteins from an animal and/or a plant material, including, but not limited to, seaweed, plants, fungi, bacteria, and animals. The term “protein concentrate” refers to a substance that has had non-protein solid constituents (i.e. excluding water) removed from the source material. For example, a protein concentrate can be produced by physical separation techniques such as membrane filtration, or grinding followed by air-classification, among others. According to the Dictionary of Food Science and Technology, “Protein concentrates are products prepared by extracting proteins from animal and plant materials such as vegetables, fish, and whey. Protein content varies among preparations. Protein concentrates are used to provide protein fortification and enhance functional properties in a wide range of foods. Some of the most commonly used concentrates in the food industry are fish protein concentrates, soy protein concentrates and whey protein concentrates.” (Wiley-Blackwell (2009). Protein concentrate. In Dictionary of Food Science and Technology, (2^{nd} Ed., p. 346). The extraction of the proteins results in the full or partial removal of non-protein solid materials, such that the final protein concentration in a protein concentrate is greater than the protein concentration in the starting material on a dry weight basis. The protein concentration can vary between different protein concentrates, even if prepared by the same method.

In an embodiment, the protein in a protein concentrate is purified to at least 45% to 99%, by dry weight, of the final material. In another embodiment, the protein in a protein concentrate is purified to at least 25%, at least 26%, at least 27%, at least 28%, at least 29%, at least 30%, at least 31%, at least 32%, at least 33%, at least 34%, at least 35%, at least 36%, at least 37%, at least 38%, at least 39%, at least 40%, at least 41%, at least 42%, at least 43%, at least 44%, at least 45%, to at least 46%, to at least 47%, to at least 48%, to at least 49% to at least 50%, to at least 51%, to at least 52%, to at least 53%, to at least 54%, to at least 55%, to at least 56%, to at least 57%, to at least 58%, to at least 59%, to at least 60%, to at least 61%, to at least 62%, to at least 63%, to at least 64%, to at least 65%, to at least 66%, to at least 67%, to at least 68%, to at least 69% to at least 70%, to at least 71%, to at least 72%, to at least 73%, to at least 74%, to at least 75%, to at least 76%, to at least 77%, to at least 78%, to at least 79%, to at least 80%, to at least 81%, to at least 82%, to at least 83%, to at least 84%, to at least 85%, to at least 86%, to at least 87%, to at least 88%, to at least 89%, to at least 90%, to at least 91%, to at least 92%, to at least 93%, to at least 94%, to at least 95%, to at least 96%, to at least 97%, to at least 98% or at least 99%, by dry weight, of the final material.

In another embodiment, the protein concentrate is purified to about 25%, about 26%, about 27%, about 28%, about 29%, about 30%, about 31%, about 32%, about 33%, about 34%, about 35%, about 36%, about 37%, about 38%, about 39%, about 40%, about 41%, about 42%, about 43%, about 44%, about 45%, to about 46%, to about 47%, to about 48%, to about 49%, to about 50%, to about 51%, to about 52%, to about 53%, to about 54%, to about 55%, to about 56%, to about 57%, to about 58%, to about 59%, to about 60%, to about 61%, to about 62%, to about 63%, to about 64%, to about 65%, to about 66%, to about 67%, to about 68%, to about 69%, to about 70%, about 71%, to about 72%, to about 73%, to about 74%, to about 75%, to about 76%, to about 77%, to about 78%, to about 79%, to about 80%, to about 81%, to about 82%, to about 83%, to about 84%, to about 85%, to about 86%, to about 87%, to about 88%, to about 89%, to about 90%, to about 91%, to about 92%, to about 93%, to about 94%, to about 95%, to about 96%, to about 97%, to about 98% or about 99%, by dry weight, of the final material.

In another embodiment, the protein concentrate is purified to 25%, to 26%, to 27%, to 28%, to 29%, to 30%, to 31%, to 32%, to 33%, to 34%, to 35%, to 36%, to 37%, to 38%, to 39%, to 40%, to 41%, to 42%, to 43%, to 44%, to 45%, to 46%, to 47%, to 48%, to 49%, to 50%, to 51%, to 52%, to 53%, to 54%, to 55%, to 56%, to 57%, to 58%, to 59%, to 60%, to 61%, to 62%, to 63%, to 64%, to 65%, to 66%, to 67%, to 68%, to 69%, to 70%, to 71%, to 72%, to 73%, to 74%, to 75%, to 76%, to 77%, to 78%, to 79%, to 80%, to 81%, to 82%, to 83%, to 84%, to 85%, to 86%, to 87%, to 88%, to 89%, to 90%, to 91%, to 92%, to 93%, to 94%, to 95%, to 96%, to 97%, to 98% or 99%, by dry weight, of the final material.

In an embodiment, a “protein concentrate” indicates that the plant protein (e.g., a heme-containing protein, wheat gluten, a seaweed protein, dehydrin protein, an albumin, a globulin, conglycinin, glycinin, a zein or a protein from any of grains (including, quinoa, barley, bulgur, farro and kasha), pulse (including, lentils, dry beans, dry broad beans, dry peas, chickpeas, cow peas, pigeon peas, Bambara beans, vetches, lupins, pulses nes), cereals (including, pearl millet, proso millet, sorghum, oats, rye, teff, triticale, finger millet, fonio, foxtail millet, kodo millet, Japanese millet, Job's Tears), pseudograins (including, amaranth, breadnut, buckwheat, chia, cockscomb, pitseed goosefoot, kaniwa, wattleseed) legumes (including, alfalfa, clover, peas, beans, lupins, mesquite, carob, soybeans, peanuts, tamarind), rice, mung beans, corn, or mixtures thereof) or plant protein fraction (e.g., a 7S fraction) has been separated from other components of the source material (e.g., other animal, plant, fungal, algal, or bacterial proteins), such that the protein or protein fraction is at least 2%, at least 3%, at least 4%, at least 5%, 10%, 20%, 25%, 30%, 35%, 40%, 45%, 50%, 55%, 60%, 65%, 70%, 75%, 80%, 85%, 90%, 95%, or 99% free, by dry weight, of the other components of the source plant or animal material.

### DESCRIPTION OF EMBODIMENTS

Plants comprise a source of proteins that can be used to create foods not typically associated with plants. This includes seafood, eggs and egg products, dairy products, including cheese, milk, ice cream and other dairy products and a meat. The meat can be from a cow, a pig, a sheep, a goat, a horse, an ostrich, a chicken, a turkey or other meat source. Among the plants from which proteins can be obtained are seaweeds. Seaweeds can be a rich source of protein as it contains up to 47% protein on a dry weight basis. Embodiments include a meat substitute that uses seaweed as source of protein. The product is devoid, or substantially devoid, of marine flavors which can be bitter. In another embodiment, the product is red, colorless or exhibits a meat-like color.

The meat substitute offers health benefits to the consumer and curbs the environmental impacts of factory farming. It can also exhibit flavors and textures to satisfy cravings of meat eaters and shift them toward a vegetarian diet.

The product is about 60-80% protein. It can be flavored and colored for a desired use or as a substitute for a particular type of meat. In one embodiment, the product is stored and shipped frozen (e.g. 4° C.). The product is thawed to produce a wafer like structure or fibrous structure, based on a first method or second method.

### Wafer Like Structure

In the first method, the protein concentrate is protein that has been precipitated at low pH (e.g. about pH 2.5). Here, the user starts with an acidic protein concentrate in liquid form. The liquid protein is frozen and thawed to create a solid matrix of protein. The matrix can be dried into a solid wafer. The wafer can be mixed with another food product (e.g. almond flour, coconut flour, hazelnut flour, gram flour (besan), pea protein, buckwheat, oat, millet, teff, brown rice, quinoa, amaranth, chickpea protein, mesquite and/or soy protein) to make, for example, a desired meat substitute, seafood substitute, snack or spread.

In an embodiment, the frozen solids are freeze dried to form a dry solid with a preserved fibrous structure.

In an embodiment transglutaminase is utilized to improve the structural integrity of the fibrous structure.

### Fibrous Structure

In the second method, the protein concentrate is a solubilized protein with a neutral pH (i.e. about pH 6-8). The pH of the precipitated protein described above can be neutralized before freezing. During freezing, the solids form into linear fibrous structures.

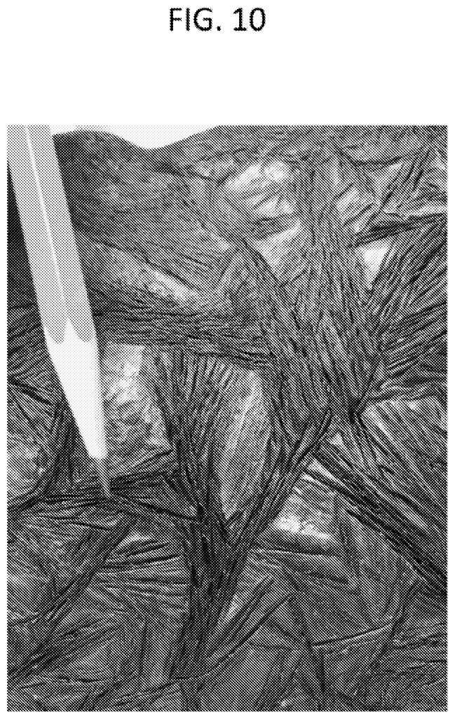

In an embodiment, the frozen solids are freeze dried to form a dry solid with a preserved fibrous structure (FIG. 10)

In an embodiment transglutaminase is utilized to improve the structural integrity of the fibrous structure.

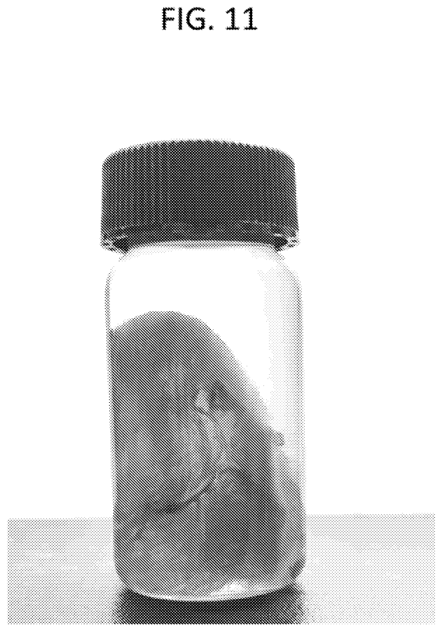

In an embodiment, the frozen solids are placed in 95% ethanol or 91% isopropanol to “fix” the structures (FIG. 11). The next step may include evaporation of ethanol to yield a material with vein-like or long red fibrous structures. The structures present potential use as scaffolding for plant-based meat.

In an embodiment, the fibrous structure produced from the methods described above are used as a scaffolding for the growth of cultures of animal tissue cells, for example for the purposes of making lab-cultured meat for consumption as human food.

In some embodiments, the protein concentrate can be used as part of, or to create a meat substitute product that can then be formulated with a meat substitute and other components, including a pH adjusting agent, a binding agent, an antioxidant, a flavoring agent, a carbohydrate and/or a fat. In one embodiment, a protein concentrate can be used as part of or to create a plant-based meat substitute product that is gluten free. In such an embodiment, a blend of the protein concentrate with maize starch, tapioca flour, rice flour, and guar gum can be used instead of the wheat gluten in a meat substitute.

In another aspect of the invention, the protein concentrate can be used as part of or to create a plant-based meat substitute product that is derived and/or obtained from a red seaweed (Rhodophyta). In an aspect of the invention, the red seaweed is Gracilaria, Porphyra, Pyropia, Kappaphycus, Eucheuma, and/or Palmaria. In a further aspect of the invention, the plant-based meat substitute product is derived from a brown seaweed (Phaeophyta). In an aspect of the invention, the brown seaweed is Undaria, Alaria, Laminaria, Sargassum, and/or Saccharina. In another aspect of the invention, the seaweed protein is derived from a green seaweed (Chlorophyta). In an aspect of the invention, the green seaweed is Ulva or Monostroma.

In an aspect of the invention, the process for producing the seaweed protein concentrate may improve the olfactory profile of a food product made with the seaweed protein concentrate. Many species of macroalgae (seaweed) have aroma profiles similar to meat, but also have a distinct “marine” flavor that is off-putting to many consumers. These volatile compounds responsible for taste and smell can be identified with GC-MS when coupled with olfactometry (GC-O-MS). The most potent aroma compounds in roasted and boiled beef are aldehydes and ketones also produced as volatiles by common brown seaweeds such as sugar kelp and wakame, and by popular red seaweeds such as nori and dulse. Aromatic compounds that contribute to fishy/marine flavors, known to include free amino acids asparagine, histidine, methionine and phenylalanine as well as the hydrocarbons pentadecane and tetradecane.

In an embodiment, a seaweed protein can be extracted from a seaweed, whether from a red, green or brown using an enzyme. In another embodiment a seaweed protein can be extracted from a seaweed, whether from a red, green or brown by making the pH during the extraction procedure more alkaline with a pH adjusting agent. in an embodiment, a protein concentrate can be made from a seaweed, including a red, green or brown seaweed. In a further embodiment, the protein concentrate from a seaweed is used to prepare a meat substitute. in another embodiment, the protein concentrate from a seaweed is mixed with a protein concentrate from one or more of a protein concentrate from wheat, grains (including, quinoa, barley, bulgur, farro and kasha), pulse (including, lentils, dry beans, dry broad beans, dry peas, chickpeas, cow peas, pigeon peas, Bambara beans, vetches, lupins, pulses nes), cereals (including, pearl millet, proso millet, sorghum, oats, rye, teff, triticale, finger millet, fonio, foxtail millet, kodo millet, Japanese millet, Job's Tears), pseudograins (including, amaranth, breadnut, buckwheat, chia, cockscomb, pitseed goosefoot, kaniwa, wattieseed) legumes (including, alfalfa, clover, peas, beans, lupins, mesquite, carob, soybeans, peanuts, tamarind), rice, mung beans, corn or an animal. In a further embodiment, the protein concentrate is from a wheat, a grain (including, quinoa, barley, bulgur, farro and kasha), pulse (including, lentils, dry beans, dry broad beans, dry peas. chickpeas, cow peas, pigeon peas, Bambara beans, vetches, lupins, pulses nes), cereals (including, pearl millet, proso millet, sorghum, oats, rye, teff, triticale, finger millet, fonio, foxtail millet, kodo millet, Japanese millet, Job's Tears), a pseudograin (including, amaranth, breadnut, buckwheat, Ghia, cockscomb, pitseed goosefoot, kaniwa, wattleseed) a legume (including, alfalfa, clover, peas, beans, lupins, mesquite, carob, soybeans, peanuts, tamarind), a rice, a mung bean or a corn. In one embodiment, the mixed protein concentrate from a seaweed and from one or more of wheat, pea soy or an animal is used to prepare a meat substitute.

In an embodiment, a protein concentrate can be used as part of, or to create a meat substitute that can include other ingredients like a protein (natural and/or modified), a carbohydrate, and/or a lipid (natural or modified form). The addition of a seaweed protein concentrate to a meat substitute can provide an improvement in the similarity of a substitute and/or an egg- or dairy substitute to look, feel and taste like a natural animal food product, such as a hamburger, a hot dog, a sausage, a steak, a chicken breast, a turkey breast, fish filet, shrimp or other product created from a natural animal food product. In an embodiment, a seaweed protein concentrate includes a concentrate that is derived from one of the three families of seaweed: either a red, a brown, and/or a green (e.g. Rhodophyta, Phaeophyta or Chlorophyta). In an embodiment, a protein fraction is enriched from the red, brown and/or green seaweed to create a meat substitute that includes a seaweed protein fraction.

### Method of Manufacture

Another embodiment is a method of manufacturing a meat substitute that contains a seaweed protein concentrate from a natural or modified seaweed and at least one other ingredient. For purposes of this embodiment, a natural or modified seaweed is used as an exemplar only and this method is not intended to be limited to only a natural or modified seaweed. This same method can also be used to manufacture a protein concentrate from other plant sources.

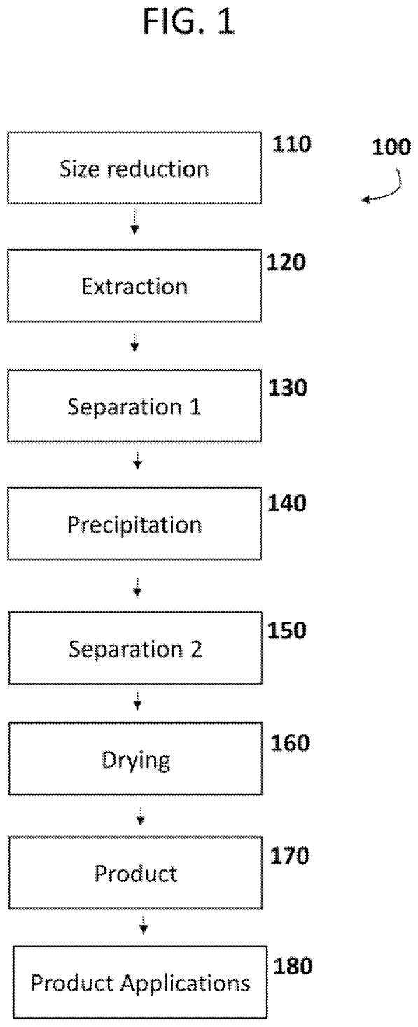

FIG. 1 depicts the process of producing a protein concentrate from a seaweed and integrating it into a plant-based meat substitute. In FIG. 1 100 sets forth the process of producing the protein concentrate according to an embodiment. In an embodiment, and if necessary, the first step is size reduction 110 to reduce the size of the pieces of seaweed, if necessary. This can be done by cutting, shredding, slicing or other method by which the size of a piece of seaweed can be reduced. This is followed by extraction 120 wherein the seaweed is suspended in an aqueous solution, in this step the pH can be increased to further extract the protein from the raw starting material. The next step is separation 130 of the aqueous solution containing solubilized protein from the residual solids. The pH of the aqueous solution is lowered to precipitate the protein 140. Then, the pH adjusted solution is separated 150 into an aqueous solution and a solid fraction containing the final protein concentrate. At this point the protein concentrate is wet. The protein concentrate is then dried 160. In an aspect, the protein concentrate is dried by spray drying to put the protein into a stable and usable form to yield the final dried protein concentrate product 170. The final protein concentrate is then integrated into plant-based meat substitutes 180.

Product applications 180 include, for example, a meat substitute (e.g. a ground beef substitute product), a seafood substitute, a protein supplement, a baked good (e.g. a bread or a cookie), and a condiment (e.g. a spread such as a mayonnaise, a mustard).

### Extraction

In an embodiment, the starting material used to create a meat substitute is obtained from a seaweed that is fresh. To be fresh means that the seaweed has been recently collected from its source, including the ocean, a farm or other location where seaweed can be grown, retains most of its native water content, and has not been subjected to intentional drying (e.g. sun drying or oven drying) or freezing. Collection includes harvesting, farming, picking or any other means for collecting seaweed from its location where it grows or is grown. In a further embodiment, a seaweed is derived and/or obtained from plant cells grown through tank aquaculture in a controlled indoor or outdoor environment. Fresh seaweed is not dried and retains moisture. In an embodiment, the seaweed has been selected by breeding or genetic modification to result in improved efficiency and/or yield of protein extraction. Alternatively, dried seaweed can be used. Prior to processing the dry seaweed, the dry seaweed may be rehydrated. Rehydration can be done with water or another liquid, including one that includes a supplement such as a salt, a protein, a vitamin or other additive. The rehydration can be conducted at a 1-5% ratio of dry seaweed to water or another liquid by weight. In an embodiment, fresh seaweed is used to increase the amount of protein extracted from the raw material.

The method begins with extraction of protein from seaweed. An obstacle to obtaining the protein from seaweed is the seaweed cell wall. The cell wall complex includes crystalline cellulose microfibrils that imparts structure and runs parallel to the surface of the cell. The human gut microblome or the gastrointestinal (GI) enzymes are unable to break down the cell wall of macroalgae to access the cellular proteins.

Studies have compared harvest times to determine the optimum time to harvest seaweeds to obtain the greatest protein yields. Accordingly, in one embodiment, the seaweed is harvested in a season or particular time of year that is most favorable to yielding high levels of protein, frequently in winter or early spring. However, year-round harvest or cultivation of seaweeds is common for certain seaweeds in Asia and some European countries. Extracting macroalgal proteins during seasons when total protein contents are lower than carbohydrates makes breaking the cell wall even more important.

Conventionally, physical methods have been used to break the cell walls: high pressure processing (HPP), an autoclave pre-treatment or protein extraction using sonication followed by ammonium sulphate saturation to salt out proteins by precipitation.

In one embodiment, the starting material is fresh seaweed that is dried. In an embodiment, the fresh seaweed is dried using UV, an external heat source or natural sunlight. In an embodiment, the drying step is selected to reduce protein hydrolysis during storage.

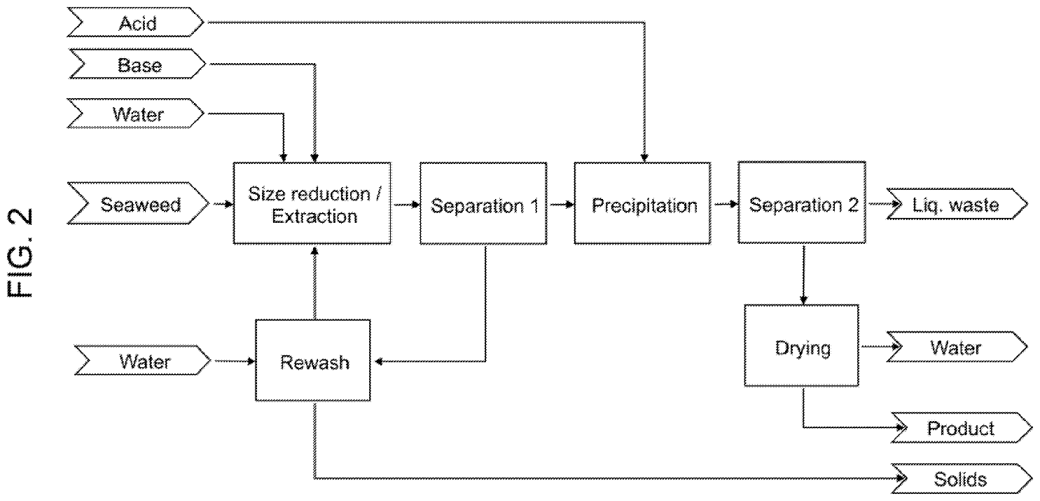

Photobleaching can occur during a drying step for seaweed or can occur at other points in the manufacturing process set forth in FIG. 1 and FIG. 2. For instance, in an embodiment photobleaching is conducted using a UV light source, natural sunlight or other means by which photobleaching of a seaweed or a protein. Photobleaching can be conducted on the dry or wet seaweed, on the resuspended solution, on the liquid collected after the first centrifugation step

In one embodiment, extraction includes an enzymatic step (i.e. enzymatic digestion). For example, alginate lyase, agarase, carrageenase (e.g. lamba-, kappa-, or iota-carrageenase), xylanase and/or cellulase can be used to break down the cell walls, hydrocolloids, and cellulose.

In one embodiment, the cells are lysed in a cold temperature (i.e. 4-10° C.).

Additional steps can be added to increase the yield of protein. For example, homogenization can also be used to yield smaller particles. This can be followed by high pressure processing. Further, temperature and pH can be varied to improve yields.

During extraction, protein is solubilized. A buffer can be added to the extracted protein to improve stability of the protein. In one embodiment, the buffer used to improve protein stability is a phosphate buffer. Further, the temperature of the buffer/solution can be adjusted and maintained to improve color.

In one embodiment, the pH is adjusted to improve protein solubilization. A more alkaline pH can favor solubility of the protein. For example, the pH can be adjusted to 8-10 to improve protein solubility. For increasing pH, NaOH or KOH are primarily used. For lowering pH, food-grade acetic acid and/or phosphoric acid can be used.

I In one embodiment, the temperature of the solution is adjusted to selectively alter the color of the material in either a wet or dried state. In an embodiment, the temperature is adjusted to selectively degrade material components imparting an undesirable color. In an embodiment, the solution may be heated to a higher temperature to decrease the blue color of the material (e.g. around 60° C.).

### Separation 1

The first separation process separates the aqueous solution from insoluble solids. The separation may be done with a centrifuge and/or filtration system. Types of centrifuges include decanting, disc stack, hydrocyclone, basket, dead end, and vertical tubular configurations. Types of filtration systems include membrane filtration, tangential flow filtration, and filter press. In an embodiment, centrifugation is followed by filtration to improve the clarity of the final aqueous solution. Sedimentation and/or centrifugation can be used to separate a first liquid solution with protein from a second solution that contains algal sediment (e.g. cell walls, etc.). In an embodiment, co-products from the algal sediment are collected for use (e.g. for use as agar films, dietary fiber, colorants, etc.).

Precipitation The next step is precipitation of solids from the aqueous solution.

In one embodiment, the pH is adjusted to 2.5-5, 4-5, 3-5, 3-4, 2.5-4 or, 2.5-3) and the temperature may be increased to increase the amount of protein precipitated, up to 80 degrees C. One or more specific acids can be used to improve flavor.

In an embodiment, the pH is adjusted to a pH of 2, 2.5, 3, 3.5, 4, 4.5, 5, 5.5, 6, 6.5, 7, 7.5, 8, 8.5, 9, 9.5, 10, 10.5, 11, 11.5 or 12.

In another embodiment, the solution is frozen to increase the amount of protein precipitated. In yet another embodiment, the solution is boiled to increase the amount of protein precipitated.

Alternatively, filtration or column chromatography can be used instead of or in addition to the precipitation step. Because the primary phycobiliprotein complex is around 250 kD, pore sizes smaller than this are preferably used (e.g. less than about 100 kD).

In an embodiment protein size is measured by molecular weight (e.g. kilodaltons).

In another embodiment protein size is measured by peptide length.

### Separation 2

The second separation step separates soluble and insoluble components. The separation may be achieved by centrifugation or filtration. The insoluble component may be resuspended in an aqueous solution and separated in the same manner in a repeated fashion. In an embodiment, the repeated separation improves the functionality of the protein fraction, e.g. taste, solubility, color, odor, etc. In another embodiment, the repeated separation step increases the protein content of the resulting protein concentrate.

In an embodiment of the second separation step, a non-polar solvent is used. In an embodiment, the non-polar solvent is an alcohol. In an embodiment, the non-polar solvent improves the functionality of the resulting protein concentrate.

### Drying

The next step is drying to put the protein concentrate into a stable and usable form. Drying techniques can improve and/or retain specific functionalities (e.g. solubility, dispersibility, and/or sensory attributes). For example, the protein solution can be freeze dried, drum dried or spray dried.

### Final Product

The resulting product of the method is a seaweed protein concentrate. In one embodiment, the product has the appearance of a meat substitute. The final product can be processed depending on its intended use. For example, umami flavor can entail incorporating specific additives to improve taste.

### Product Applications

To incorporate the protein concentrate into meat substitutes, the umami flavor or marine flavors can be enhanced or masked by incorporating specific additives, such as salt and seasonings to improve taste. In an embodiment, citric acid may be used as an acid in one of the protein concentrate manufacturing steps (e.g. precipitation) to mask a fishy/marine flavor in an application as a meat substitute or can be added to the protein concentrate when combining with other ingredients to make a meat substitute.

Further, the protein concentrate may be mixed with other proteins, fats, and carbohydrates to improve the sensory attributes, color, nutritional profile, cooking behavior, etc. of meat substitutes.

### Alternative Processing Method

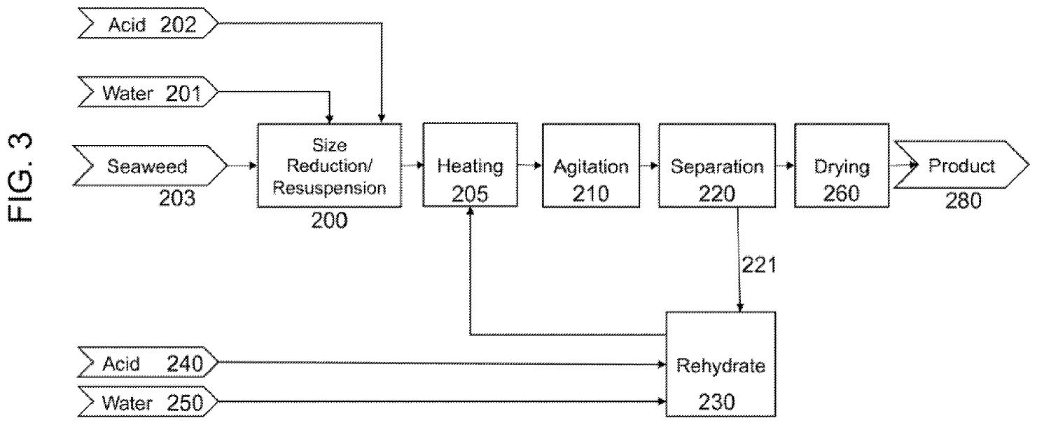

FIG. 3 depicts the process of producing a protein concentrate from a seaweed. In an embodiment, this method is be employed when valuable carbohydrate (e.g. hydrocolloid) and protein fractions have relatively enriched or depleted concentrations within distinct physical or structural components of the intact seaweed macrostructure. The method may be used to improve the efficiency or lower the cost of fractionation when the different components of seaweed biomass exhibit non-uniform response to physical, chemical, or enzymatic methods of fractionation. In an embodiment, the cells of certain structural components remain intact in response to the fractionation treatment while other structural components are solubilized and/or the cell walls ruptured. In an embodiment, components of seaweed that are physically separated from other parts of the seaweed biomass with the method may include the cortex, medulla, sporangia, cuticula, cortex, mucilage, thallus, blade, or holdfast. In certain embodiments, a structural component separated from other parts of the seaweed is relatively enriched in protein as compared to other components. In certain seaweeds, for example the red seaweed Gracilaria, the outer cortex of the thallus contains phycoerythrin, a red colored phycobiliprotein. The cortex surrounds the inner medulla, which forms a tube-like structure that is transparent and colorless and is rich in the hydrocolloid agar. Both are economically valuable components and can be separated using the method described herein. In one embodiment, the source of the protein concentrate is an agar containing plant source, including seaweed, wherein the protein concentrate can be obtained by melting or hydrolyzing the agar. In an embodiment, the method is used to separate a protein enriched component from an alginate containing component. In another embodiment, the method is used to separate a protein enriched component from a carrageenan containing component.

In an embodiment, the plant source includes a material that includes an acid hydrolysable and gelatinous material. In an embodiment the acid hydrolysable material comprises at least 5%, at least 10%, at least 15%, at least 20%, at least 25%, at least 30%, at least 35%, at least 40%, at least 45%, at least 50%, at least 55%, at least 60%, at least 65%, at least 70%, at least 75%, at least 80%, at least 85%%, at least 90% or at least 95% of the dry mass. In another embodiment, acid hydrolysable material comprises no more than 5%, no more than 10%, no more than 15%, no more than 20%, no more than 25%, no more than 30%, no more than 35%, no more than 40%, no more than 45%, no more than 50%, no more than 55%, no more than 60%, no more than 65%, no more than 70%, no more than 75%, no more than 80%, no more than 85%%, no more than 90% or no more than 95% of the dry mass.

In a further embodiment, the acid hydrolysable material comprises about 5%, about 10%, about 15%, about 20%, about 25%, about 30%, about 35%, about 40%, about 45%, about 50%, about 55%, about 60%, about 65%, about 70%, about 75%, about 80%, about 85%%, about 90% or about 95% of the dry mass.

In one embodiment, the process set forth in FIG. 3 is useful for a protein containing material, such as certain types of seaweed, in which it is difficult to extract protein using the methods depicted in FIG. 2. (water and/or high pH methods). It is also useful for separating into different fractions a seaweed that contains a protein fraction and a carbohydrate fraction. FIG. 3 sets forth the process of producing the protein concentrate using a dry seaweed according to an embodiment of the process set forth in FIG. 3. As is understood any plant source can be used in place of seaweed in this process. This process can be used for any agar containing plant or other plant that contains a component that can be hydrolyzed and/or melted. In an embodiment, the seaweed may be a red seaweed, a green seaweed, or a brown seaweed.

In an embodiment, and if the seaweed to be processed is dry, the first step is to cut the dry seaweed into pieces of one inch or smaller; e.g. 10 millimeters. In an embodiment, these pieces can be larger than 1 inch, for instance, 5 inches, 4 inches, 3 inches, 2 inches or less than 1 inch, for instance, 9/10 inch, 8/10 inch, 7/10 inch, 6/10 inch, 5/10 inch, 4/10 inch, 3/10 inch, 2/10 inch, 1/10 inch or smaller or their millimeter equivalents. These sizes of cut seaweed are also useful for the other methods of processing set forth herein, including those set forth in FIG. 1 and FIG. 2. In an embodiment, to reduce the size of the seaweed, the following can be used, including cutting, shredding, slicing, chopping, milling, or other methods by which the size of a piece of seaweed can be reduced. In an embodiment, the pieces of seaweed are separated by physical property (e.g. diameter, mass, density, or length) to improve the efficiency of the protein separation process. In an embodiment, larger diameter pieces of seaweed are separated (e.g. by air classification, vibrating screen, or sieve) and selected for processing together. In an embodiment, the selection of larger diameter pieces increases the efficiency of separation of the cells in the outer cortex and the cells in the inner medulla of the seaweed thallus and/or blade. In another embodiment, smaller diameter pieces are selected to improve the separation and/or extraction process. In another embodiment, different sizes of seaweed pieces are sent to different separation processes.

The next step is to suspend 200 the dry seaweed (or other plant or non-animal-based material) by adding water or similar liquid to rehydrate the dry seaweed 203. The water can be added at a ratio of 1:10 dry seaweed to water (wt/wt). Other ratios include 1:9, 1:8, 1:7, 1:6, 1:5, 1:4, 1:3, 1:2, 1:1, 2:1, 3:1, 4:1, 5:1, 6:1, 7:1, 8:1, 9:1 or 10:1 dry seaweed to water (wt/wt).

In the next step, the seaweed is heated 205 to allow for the separation of protein-rich components from other components found in the seaweed (or other plant or non-animal-based material). In another embodiment, the size reduction 200 and heating 205 are done at the same time. In another embodiment, the heating and/or extraction causes the structurally distinct components of the seaweed to detach from each other, e.g. by swelling, peeling, delaminating, or a differential rate of dissolution and/or hydrolysis. Following heating 205, the heated seaweed material is agitated 210. In an embodiment, agitation 210 can be gentle, moderate or aggressively conducted. In an embodiment, agitation is achieved by stirring. In another embodiment, agitation is achieved by sonication. In another embodiment, agitation is achieved by high pressure, spraying, scraping, beating, or pressing the seaweed material. During heating and agitation, physically distinct multicellular components, such as the outer cortex, may detach from the other components of the seaweed, such as the medulla. During agitation, the pH can be decreased by gently mixing in an acid 202 to assist in separating the protein-rich components from the other seaweed components, which may include carbohydrate rich components. An example of an acid that is usable in this process is phosphoric acid, which in an embodiment is used to adjust the pH to 2.5. Other acids that can be used include, citric acid, acetic acid, fumaric acid, lactic acid, malic acid and tartaric acid. In an embodiment, the seaweed is

The size reduced 200 and heated 205 seaweed solution is heated to a temperature of 60° C. to 90° C. In an embodiment, the size reduced seaweed solution is heated to a temperature of at least 60° C., at least 65° C., at least 70° C., at least 75° C., at least 80° C., at least 85° C. or at least 90 ° C. In an embodiment, the size reduced seaweed solution is heated to a temperature of no more 60° C., no more 65° C., no more 70° C., no more 75° C., no more 80° C., no more 85° C. or no more 90 ° C. In an embodiment, the size reduced seaweed 200 solution is heated to a temperature of about 60° C., about 65° C., about 70° C., about 75° C., about 80° C., about 85° C. or about 90° C. Heating of the resuspended 200 solution can be accomplished using a hot water bath into which the solution is placed, a heated liquid solution into which the solution is placed or another heat source that is used to heat a solution, including, but not limited to, an electrical heat source, a gas heat source or a flammable liquid heat source. The size reduced 200 seaweed solution can be heated for a period of 10 minutes, 15 minutes, 20 minutes, 25 minutes, 30 minutes, 35 minutes, 40 minutes, 45 minutes, 50 minutes, 55 minutes, 60 minutes, 75 minutes, 90 minutes, 105 minutes, 120 minutes, 3 hours, 4 hours, 5 hours 6 hours, 7 hours, 8 hours, 9 hours, 10 hours, 15 hours, 24 hours, 2 days, 3 days, 4 days, 5 days, 6 days, 7 days or more. The step to heat 205 the solution can be repeated one, two, three, four, five, six, seven, eight, nine or ten times before the heated 205 solution is put through the separation 220 step.

The heated 205 solution is next agitated 210 and put through a procedure to separate 220 the carbohydrate-rich components 221 from the protein-rich components. Different procedures can be used to carry out the separation procedure 220, including centrifugation, column chromatography, a sieve or a porous cloth or other material through which the heated 205 solution can be poured through to separate out the carbohydrate-rich components from the protein concentrate. For column chromatography the separation can be conducted using a separation material with one or more pore sizes, wherein at least one pore size has the ability to retain the carbohydrate-rich components 221 while allowing the protein concentrate in the solution to pass through. The same is true of a sieve or a cloth made of a porous material, wherein one or more sieves or cloths can be used of varying pore sizes such that the carbohydrate-rich components 221 can be separated from the protein concentrate that remains in the solution. In an embodiment, a sieve is made of metal, plastic, ceramic, cloth or another material that is capable of providing a fixed structure. The sieve can be constructed of glass, metal, plastic or a synthetic material. The sieve can have a pore size of 100 microns, 200 microns, 300 microns, 400 microns, 500 microns, 600 microns, 700 microns, 800 microns, 900 microns, 1000 microns, 1100 microns, 1200 microns, 1300 microns, 1400 microns, 1500 microns, 1600 microns, 1700 microns, 1800 microns, 1900 microns, 2000 microns, 2100 microns, 2200 microns, 2300 microns, 2400 microns or 2500 microns or more. The separation can use multiple sieves wherein subsequent sieves have a smaller pore size than the prior sieve.

In an embodiment, the carbohydrate-rich components 221 can be rehydrated with water 250 and, if necessary, to rehydrate with an acid 240 and the resolubilized material 221 is then heated 210 again, reagitated 210 and separation 220 is carried out again. When rehydrated with an acid, the pH of the carbohydrate-rich components are adjusted to a pH of 2.5. The resulting carbohydrate-rich components 221 from this second round of heating 205 and separation 220 can be resolubilized, reheated 205 and reseparated 220 one or more times until a majority of the protein concentrate can be removed from the carbohydrate-rich components 221. The rehydration of the carbohydrate-rich components, followed by heating, separation and then rehydration can be repeated one, two, three, four, five, six, seven, eight, nine or ten times before the protein concentration in solution is put through the drying 260 step.

In an embodiment, separation of the carbohydrate-rich components from the protein concentrate in solution results in two, three, four, five, six, seven, eight, nine or ten different fractions. In an embodiment, separation of the carbohydrate-rich component from the protein concentrate results in two fractions, one containing a protein concentrate and one containing a carbohydrate. In an embodiment, the protein concentrate is the heavier fraction and the carbohydrate is the lighter fraction.

Both the protein concentrate and the carbohydrate-rich component can be collected and used in a product. In an embodiment, the carbohydrate-rich fraction can be used in a product for ingestion by an animal. In an embodiment, an animal includes, a human, a cow, a horse, a goat, a sheep, a guinea pig, a pig, a rodent, a rat and a mouse. In an embodiment, the carbohydrate rich fraction includes a sulfated polysaccharide. In an embodiment, the carbohydrate rich fraction is treated with alkali to remove sulfate groups. In an embodiment, the carbohydrate rich fraction includes a hydrocolloid (e.g. agar, carrageenan, or alginate). In an embodiment, the carbohydrate rich fraction is treated with alkali to improve the gel strength of the hydrocolloid fraction. In an embodiment, the carbohydrate rich fraction is treated with alkali to form a sodium salt.

Prior to being dried 260, the protein concentrate and/or the carbohydrate-rich fraction can, in an embodiment, be subjected to an enzymatic digestion. In an embodiment, the enzymatic digestion reduces the size of the protein comprising the protein concentrate. In another embodiment, the enzymatic digestion reduces the size of the carbohydrate comprising the carbohydrate-rich fraction. In an embodiment, an enzyme to digest a carbohydrate includes alginate lyase, agarase, carrageenase, amylase, maltase, sucrase, lactase, or isomaltase. In an embodiment, enzyme digestion changes the flavor of the protein concentrate and/or carbohydrate-rich fraction. In a further embodiment, enzyme digestion increases the functionality for use of the protein concentrate and/or carbohydrate-rich fraction.

The protein concentrate in solution can then be dried 260. In an embodiment, the protein concentrate is dried by spray drying to put the protein into a stable and usable form to yield the final dried protein concentrate product 280. Other methods to dry the protein concentrate include freeze drying, drum drying, drying using a heat source, drying in the sun, drying in the presence of a desiccant or other drying method that is commonly used to dry a protein in a liquid. Other methods known in the art can also be used.

The dried protein concentrate can then be used as part of a meat substitute product or other product which can contain a protein concentrate. Examples include products that use protein concentrates such as whey protein concentrate.

Similarly, the carbohydrate-rich fraction can also be dried 260 using the same means as that for the protein concentrate. These include, freeze drying, drum drying, drying using a heat source, drying in the sun, drying in the presence of a desiccant or other drying methods that are commonly used to dry a carbohydrate in a liquid. The carbohydrate-rich fraction can be dried 260 at the same time as the protein concentrate or at a different time, including sequentially. The carbohydrate-rich fraction can be dried 260 using the same method as is used for the protein concentrate, including in the same apparatus, such as a freeze dryer, drum dryer, a heat source, a desiccant or other drying methods that are commonly used to dry a protein and a carbohydrate.

In an alternative embodiment, the protein concentrate is not dried, but remains in solution. In a further embodiment, the protein concentrate and the carbohydrate-rich fraction are not dried.

### Product Applications

In one embodiment, the product is a wafer-like structure. Product applications include, for example, mixing the product with another food product (e.g. almond flour) to make a desired meat substitute, seafood substitute, snack or spread. In an embodiment, the product is a powder. Alternatively, the product has a fibrous structure that can be used as a component in plant-based meat. The fibrous structure is also conducive as a scaffolding for cell-cultured meats.

In one embodiment, the product is combined with protein from a non-seaweed source (e.g. other plant, synthetically produced or animal).

In an aspect of the invention, a plant-based meat substitute is comprised of about 1% to about 90% of a seaweed protein concentrate or other plant-based protein concentrate, about 1% to about 90% of a non-seaweed protein concentrate, about 0% to about 30% carbohydrate, and about 1% to 30% lipid. In another aspect of the invention, the meat substitute is a seaweed protein concentrate or other plant-based protein concentrate containing 35-90% protein. In a further aspect of the invention the plant-based meat substitute product, the protein fraction of the seaweed protein concentrate or other plant-based protein concentrate is at least 25% phycoerythrin. In an aspect of the invention, the plant-based meat substitute product has a seaweed protein concentrate or other plant-based protein concentrate comprising a polyphenol content from about 0.1% to 10%.

In a further embodiment of the invention the protein fraction of the protein concentrate is at least 25% phycoerythrin. In another embodiment, the seaweed protein concentrate or other plant-based protein concentrate is at least 1%, at least 2%, at least 3%, at least 4%, at least 5%, at least 6%, at least 7%, at least 8%, at least 9%, at least 10%, at least 11%, at least 12%, at least 13%, at least 14%, at least 15%, at least 16%, at least 17%, at least 18%, at least 19%, at least 20%, at least 21%, at least 22%, at least 23%, at least 24%, at least 25%, at least 26%, at least 27%, at least 28%, at least 29%, at least 30%, at least 31%, at least 32%, at least 33%, at least 34%, at least 35%, at least 36%, at least 37%, at least 38%, at least 39%, at least 40%, at least 41%, at least 42%, at least 43%, at least 44%, at least 45%, at least 46%, at least 47%, at least 48%, at least 49%, at least 50%, at least 51%, at least 52%, at least 53%, at least 54%, at least 55%, at least 56%, at least 57%, at least 58%, at least 59%, at least 60%, at least 61%, at least 62%, at least 63%, at least 64%, at least 65%, at least 66%, at least 67%, at least 68%, at least 69%, at least 70%, at least 71%, at least 72%, at least 73%, at least 74%, at least 75%, at least 76%, at least 77%, at least 78%, at least 79%, at least 80%, at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99% or at least 100% phycoerythrin. A phycoerythrin can be a B-phycoerythrin (B-PE), a R-phycoerythrin (R-PE) and/or a C-phycoerythrin.

In another embodiment, the protein concentrate is comprised of about 1%, about 2%, about 3%, about 4%, about 5%, about 6%, about 7%, about 8%, about 9%, about 10%, about 11%, about 12%, about 13%, about 14%, about 15%, about 16%, about 17%, about 18%, about 19%, about 20%, about 21%, about 22%, about 23%, about 24%, about 25%, about 26%, about 27%, about 28%, about 29%, about 30%, about 31%, about 32%, about 33%, about 34%, about 35%, about 36%, about 37%, about 38%, about 39%, about 40%, about 41%, about 42%, about 43%, about 44%, about 45%, about 46%, about 47%, about 48%, about 49%, about 50%, about 51%, about 52%, about 53%, about 54%, about 55%, about 56%, about 57%, about 58%, about 59%, about 60%, about 61%, about 62%, about 63%, about 64%, about 65%, about 66%, about 67%, about 68%, about 69%, about 70%, about 71%, about 72%, about 73%, about 74%, about 75%, about 76%, about 77%, about 78%, about 79%, about 80%, about 81%, about 82%, about 83%, about 84%, about 85%, about 86%, about 87%, about 88%, about 89%, about 90%, about 91%, about 92%, about 93%, about 94%, about 95%, about 96%, about 97%, about 98%, about 99% or about 100% phycoerythrin.

In another embodiment, the protein concentrate is comprised of no more than 1%, no more than 2%, no more than 3%, no more than 4%, no more than 5%, no more than 6%, no more than 7%, no more than 8%, no more than 9%, no more than 10%, no more than 11%, no more than 12%, no more than 13%, no more than 14%, no more than 15%, no more than 16%, no more than 17%, no more than 18%, no more than 19%, no more than 20%, no more than 21%, no more than 22%, no more than 23%, no more than 24%, no more than 25%, no more than 26%, no more than 27%, no more than 28%, no more than 29%, no more than 30%, no more than 31%, no more than 32%, no more than 33%, no more than 34%, no more than 35%, no more than 36%, no more than 37%, no more than 38%, no more than 39%, no more than 40%, no more than 41%, no more than 42%, no more than 43%, no more than 44%, no more than 45%, no more than 46%, no more than 47%, no more than 48%, no more than 49%, no more than 50%, no more than 51%, no more than 52%, no more than 53%, no more than 54%, no more than 55%, no more than 56%, no more than 57%, no more than 58%, no more than 59%, no more than 60%, no more than 61%, no more than 62%, no more than 63%, no more than 64%, no more than 65%, no more than 66%, no more than 67%, no more than 68%, no more than 69%, no more than 70%, no more than 71%, no more than 72%, no more than 73%, no more than 74%, no more than 75%, no more than 76%, no more than 77%, no more than 78%, no more than 79%, no more than 80%, no more than 81%, no more than 82%, no more than 83%, no more than 84%, no more than 85%, no more than 86%, no more than 87%, no more than 88%, no more than 89%, no more than 90%, no more than 91%, no more than 92%, no more than 93%, no more than 94%, no more than 95%, no more than 96%, no more than 97%, no more than 98%, no more than 99% or no more than 100% phycoerythrin.

In an embodiment, a fresh seaweed or other plant retains about 25%, about 26%, about 27%, about 28%, about 29%, about 30%, about 31%, about 32%, about 33%, about 34%, about 35%, about 36%, about 37%, about 38%, about 39%, about 40%, about 41%, about 42%, about 43%, about 44%, about 45%, about 46%, about 47%, about 48%, about 49%, about 50%, about 51%, about 52%, about 53%, about 54%, about 55%, about 56%, about 57%, about 58%, about 59%, about 60%, about 61%, about 62%, about 63%, about 64%, about 65%, about 66%, about 67%, about 68%, about 69%, about 70%, about 71%, about 72%, about 73%, about 74%, about 75%, about 76%, about 77%, about 78%, about 79%, about 80%, about 81%, about 82%, about 83%, about 84%, about 85%, about 86%, about 87%, about 88%, about 89%, about 90%, about 91%, about 92%, about 93%, about 94%, about 95%, about 96%, about 97%, about 98%, about 99% or about 100% of its moisture as compared to a seaweed or other plant before collection.

In an embodiment, a fresh seaweed or other plant retains at least 25%, at least 26%, at least 27%, at least 28%, at least 29%, at least 30%, at least 31%, at least 32%, at least 33%, at least 34%, at least 35%, at least 36%, at least 37%, at least 38%, at least 39%, at least 40%, at least 41%, at least 42%, at least 43%, at least 44%, at least 45%, at least 46%, at least 47%, at least 48%, at least 49%, at least 50%, at least 51%, at least 52%, at least 53%, at least 54%, at least 55%, at least 56%, at least 57%, at least 58%, at least 59%, at least 60%, at least 61%, at least 62%, at least 63%, at least 64%, at least 65%, at least 66%, at least 67%, at least 68%, at least 69%, at least 70%, at least 71%, at least 72%, at least 73%, at least 74%, at least 75%, at least 76%, at least 77%, at least 78%, at least 79%, at least 80%, at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99% or at least 100% of its moisture as compared to a seaweed or another plant before collection.

To be fresh means that the seaweed or another plant was collected within 1 hour, 2 hours, 3 hours, 4 hours, 5 hours, 6 hours, 7 hours, 8 hours, 9 hours, 10 hours, 11 hours, 12 hours, 13 hours, 14 hours, 15 hours, 16 hours, 17 hours, 18 hours, 19 hours, 20 hours, 21 hours, 22 hours, 23 hours, 24 hours, 30 hours, 36 hours, 42 hours, 48 hours, 54 hours, 60 hours, 66 hours, 72 hours, 78 hours, 84 hours, 90 hours, 100 hours, 106 hours, 112 hours, 118 hours, 124 hours, 6 days, 7 days, 8 days, 9 days, 10 days, 11 days, 12 days, 13 days, 14 days, 15 days, 16 days, 17 days, 18 days, 19 days, 20 days, 21 days, 22 days, 23 days, 24 days or more.

In an embodiment, the starting material used to create a meat substitute is obtained from a seaweed or another plant that is dry. In one embodiment, for seaweed or another plant to be dry means that the seaweed or another plant has had some or all of the water in the seaweed or another plant removed. Removal can be by means such as air drying, exposing the seaweed or another plant to a heat source, exposing the seaweed or another plant to a desiccant or other means known that are used to dry a plant such as a seaweed or another plant.

In an embodiment, a fresh seaweed or another plant has had about 25%, about 26%, about 27%, about 28%, about 29%, about 30%, about 31%, about 32%, about 33%, about 34%, about 35%, about 36%, about 37%, about 38%, about 39%, about 40%, about 41%, about 42%, about 43%, about 44%, about 45%, about 46%, about 47%, about 48%, about 49%, about 50%, about 51%, about 52%, about 53%, about 54%, about 55%, about 56%, about 57%, about 58%, about 59%, about 60%, about 61%, about 62%, about 63%, about 64%, about 65%, about 66%, about 67%, about 68%, about 69%, about 70%, about 71%, about 72%, about 73%, about 74%, about 75%, about 76%, about 77%, about 78%, about 79%, about 80%, about 81%, about 82%, about 83%, about 84%, about 85%, about 86%, about 87%, about 88%, about 89%, about 90%, about 91%, about 92%, about 93%, about 94%, about 95%, about 96%, about 97%, about 98%, about 99% or about 100% of its moisture removed through drying as compared to a seaweed before collection.

In an embodiment, a fresh seaweed or another plant has had at least 25%, at least 26%, at least 27%, at least 28%, at least 29%, at least 30%, at least 31%, at least 32%, at least 33%, at least 34%, at least 35%, at least 36%, at least 37%, at least 38%, at least 39%, at least 40%, at least 41%, at least 42%, at least 43%, at least 44%, at least 45%, at least 46%, at least 47%, at least 48%, at least 49%, at least 50%, at least 51%, at least 52%, at least 53%, at least 54%, at least 55%, at least 56%, at least 57%, at least 58%, at least 59%, at least 60%, at least 61%, at least 62%, at least 63%, at least 64%, at least 65%, at least 66%, at least 67%, at least 68%, at least 69%, at least 70%, at least 71%, at least 72%, at least 73%, at least 74%, at least 75%, at least 76%, at least 77%, at least 78%, at least 79%, at least 80%, at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99% or at least 100% of its moisture removed through drying as compared to a seaweed or another plant before collection.

In an embodiment, a fresh seaweed or another plant retains no more than 25%, no more than 26%, no more than 27%, no more than 28%, no more than 29%, no more than 30%, no more than 31%, no more than 32%, no more than 33%, no more than 34%, no more than 35%, no more than 36%, no more than 37%, no more than 38%, no more than 39%, no more than 40%, no more than 41%, no more than 42%, no more than 43%, no more than 44%, no more than 45%, no more than 46%, no more than 47%, no more than 48%, no more than 49%, no more than 50%, no more than 51%, no more than 52%, no more than 53%, no more than 54%, no more than 55%, no more than 56%, no more than 57%, no more than 58%, no more than 59%, no more than 60%, no more than 61%, no more than 62%, no more than 63%, no more than 64%, no more than 65%, no more than 66%, no more than 67%, no more than 68%, no more than 69%, no more than 70%, no more than 71%, no more than 72%, no more than 73%, no more than 74%, no more than 75%, no more than 76%, no more than 77%, no more than 78%, no more than 79%, no more than 80%, no more than 81%, no more than 82%, no more than 83%, no more than 84%, no more than 85%, no more than 86%, no more than 87%, no more than 88%, no more than 89%, no more than 90%, no more than 91%, no more than 92%, no more than 93%, no more than 94%, no more than 95%, no more than 96%, no more than 97%, no more than 98%, no more than 99% or no more than 100% of its moisture as compared to a seaweed or another plant before collection.

In an embodiment, a flavoring agent can include one or more flavor precursors, a flavoring, or a flavoring compound. In one embodiment, a flavoring agent can be a combination of a flavoring and one or more flavor precursors. In a further embodiment, a binding agent can include one or more proteins that have been chemically or enzymatically modified to improve their textural and/or flavor properties, or to modify their denaturation and gelling temperatures. In a further embodiment, one or more flavoring agents can be a sugar, a sugar alcohol, a sugar acid, a sugar derivative, an oil, a free fatty acid, an amino acid or derivative thereof, a nucleoside, a nucleotide, a vitamin, an acid, a peptide, a phospholipid, a protein hydrolysate, a yeast extract, or a mixture thereof. For example, the flavor precursor can be selected from the group consisting of glucose, fructose, ribose, arabinose, glucose-6-phosphate, fructose 6-phosphate, fructose 1,6-diphosphate, inositol, maltose, sucrose, maltodextrin, glycogen, nucleotide-bound sugars, molasses, a phospholipid, a lecithin, inosine, inosine monophosphate (IMP), guanosine monophosphate (GMP), pyrazine, adenosine monophosphate (AMP), lactic acid, succinic acid, glycolic acid, thiamine, creatine, pyrophosphate, vegetable oil, algal oil, sunflower oil, corn oil, soybean oil, palm fruit oil, palm kernel oil, safflower oil, flaxseed oil, rice bran oil, cottonseed oil, olive oil, sunflower oil, canola oil, flaxseed oil, coconut oil, mango oil, a free fatty acid, cysteine, methionine, isoleucine, leucine, lysine, phenylalanine, threonine, tryptophan, valine, arginine, histidine, alanine, asparagine, aspartate, glutamate, glutamine, glycine, proline, serine, tyrosine, glutathione, an amino acid derivative, urea, pantothenic acid, ornithine, niacin, glycerol, citrulline, taurine, biotin, borage oil, fungal oil, blackcurrant oil, betaine, beta carotene, B-vitamins, N-Acetyl L-cysteine, iron glutamate and a peptone, or mixtures thereof. In another embodiment, the flavoring agent can be selected from the group consisting of a vegetable extract, a fruit extract, an acid, an antioxidant, a carotenoid, a lactone, and/or any combination of flavoring agents.

In another embodiment, a flavoring agent can include a lactone selected from the group consisting of tetrahydro-6-methyl-2H-pyran-2-one, delta-octalactone, 5-ethyldihydro-2(3H)-furanone, butyrolactone, dihydro-5-pentyl-2(3H)-furanone, dihydro-3-methylene-2,5-furandione, 1-pentoyl lactone, tetrahydro-2H-pyran-2-one, 6-heptyltetrahydro-2H-pyran-2-one, .gamma.-octalactone, 5-hydroxymethyldihydrofuran-2-one, 5-ethyl-2(5H)-furanone, 5-acetyldihydro-2(3H)-furanone, trans-3-methyl-4-octanolide 2(5H)-furanone, 3-(1,1-dimethylethyl)-2,5-urandione, 3,4-dihydroxy-5-methyl-dihydrofuran-2-one, 5-ethyl-4-hydroxy-2-methyl-3(2H)-furanone, 6-tetradecalactone, and dihydro-4-hydroxy-2(3H)-furanone. In some embodiments, the lactones can be 5-ethyl-4-hydroxy-2-methyl-3(2H)-furanone, butyrolactone, gamma-octalactone, and 6-tetradecalactone.

In another embodiment, a flavoring agent can be a juice from a plant, including a vegetable. The juice can be a vegetable puree, a vegetable extract, a fruit juice, a fruit puree, or a fruit extract. In an embodiment, a vegetable juice, vegetable puree, vegetable extract, a fruit juice, a fruit puree, or a fruit extract is a Cucumis juice, puree, or extract from a cucumber or a melon. In an embodiment, the proteins in a vegetable juice, vegetable puree, vegetable extract, fruit juice, fruit puree, or fruit extract are denatured. Denaturation can be done by cooking or otherwise treating a protein prior to its addition to a plant-based meat substitute product. In one embodiment, the vegetable juice, vegetable puree, vegetable extract, fruit juice, fruit puree, or fruit extract can be denatured by heating to about 40 degree. C., to about 50 degree. C., to about 60 degree. C., to about 70 degree. C., to about 80 degree. C., to about 90 degree. C., to about 100 degree. C., to about 110 degree. C., to about 120 degree. C. or to about 130.degree. C. prior to addition to the plant-based meat substitute product.

In an embodiment, a meat substitute or other use of a plant-based protein concentrate is made to have a flavor that is close to or replicates meat or other food product from an animal by using one or more carotenoids, wherein the carotenoids are selected from the group consisting of (3-carotene, zeaxanthin, lutein, trans-(3-apo-8′-carotenal, lycopene, canthaxanthin, and combinations thereof.

In an embodiment, a “meat substitute” product is a food product in which the product imitates the form, texture, look, feel, color, smell, appearance, consistency, taste and/or shape of a meat commonly consumed by humans, without comprising meat from an animal. A “plant-based meat substitute” is a meat substitute comprised of source material derived from plants and other non-animal organisms (e.g. fungi). Commonly known types of meat are a steak, a filet, a nugget (e.g. a chicken nugget), a drumstick, a tenderloin, a strip, a tender (e.g. a chicken tender), shreds (e.g. pulled pork), a burger, a sausage, a meatball, a deli slice, and a salami. Commonly known types of meat consumed as seafood include a fish cake, a crab cake, a fish filet, a slice of sashimi, a shrimp, a piece of surimi, a clam, a lobster, and an oyster. A meat can include only the meat portion or can include other aspects associated with meat such as a bone, a tendon or fat. For instance, in an embodiment, a meat can be a steak, such as a t-bone or a ribeye that includes the meat portion, a fat portion and a bone or bones in the steak. In an embodiment, a plant-based meat substitute product comprises plant-based analogs resembling a meat portion, a fat portion and/or a bone portion. In an embodiment, a meat substitute imitates an egg, a cheese, or a milk. In another embodiment, a plant-based meat substitute product is one that uses a protein from a plant to create a plant-based meat substitute product. In this embodiment, one or more of the proteins used to create the meat substitute product is from a plant. In an embodiment, the plant from which one or more proteins are obtained is a seaweed. In another embodiment, the plant proteins can be from more than one plant. For instance, the plant proteins can be from a pea, a soybean, a lentil and/or a seaweed. In another embodiment, the proteins used to make a meat substitute product comprise proteins from a plant and an animal.

In an embodiment, a meat portion is that part of the meat that is comprised of muscle tissue of an animal. In an embodiment, the meat portion of a plant-based meat substitute product is that portion of the meat substitute product that has the form, texture, look, feel, color, smell, appearance, consistency, taste and/or shape of a muscle of an animal. For example, for the meat portion of a cow, the plant-based meat substitute product would have a pinkish, reddish, reddish-purple color. In another embodiment, the plant-based meat substitute product that is meant to mimic the meat of a cow may have muscle like striations, have the feel and chewiness of a meat from a cow and can or may change colors from a pinkish, reddish, reddish-purple color to a brownish color upon heating. Similarly, the plant-based meat substitute product of a chicken, deer, elk, moose, turkey, goat, sheep, ostrich or horse would also have the look, feel and chewiness associated with the meat from each of these animals. For instance, the meat of a chicken would be a light color, such as white, off white, or other light color commonly associated with the meat of a chicken.

In an embodiment, the meat portion of a plant-based meat substitute product mimics the color of the animal that the plant-based meat substitute product is to mimic. In a further embodiment, the plant-based meat substitute product comprises a portion that mimics a bone (also herein referred to as a bone portion) in the plant-based meat substitute product. In this embodiment, the bone is white. In a further embodiment, the bone has a tougher and stronger consistency than the meat portion of the same plant-based meat substitute product.

In an embodiment, a flavoring agent can include a polar group, including those the group consisting of choline, ethanolamine, serine, phosphate, glycerol-3-phosphate, inositol and inositol phosphates. In another embodiment, flavoring agents can include (e.g., 5′-ribonucleotide salts, glumatic acid salts, glycine salts, guanylic acid salts, hydrolyzed proteins, hydrolyzed vegetable proteins, insomniac acid salts, monosodium glutamate, sodium chloride, galacto-oligosaccharides, sorbitol, animal meat flavor, animal meat oil, artificial flavoring agents, aspartamine, fumarate, garlic flavor, herb flavor, malate, natural flavoring agents, natural smoke extract, natural smoke solution, onion flavor, shiitake extract, spice extract, spice oil, sugars, yeast extract).

In an embodiment, the bone portion of a plant-based meat substitute product is at least 1%, at least 2%, at least 3%, at least 4%, at least 5%, at least 6%, at least 7%, at least 8%, at least 9%, at least 10%, at least 11%, at least 12%, at least 13%, at least 14%, at least 15%, at least 16%, at least 17%, at least 18%, at least 19%, at least 20%, at least 21%, at least 22%, at least 23%, at least 24%, at least 25%, at least 26%, at least 27%, at least 28%, at least 29%, at least 30%, at least 31%, at least 32%, at least 33%, at least 34%, at least 35%, at least 36%, at least 37%, at least 38%, at least 39%, at least 40%, at least 41%, at least 42%, at least 43%, at least 44%, at least 45%, at least 46%, at least 47%, at least 48%, at least 49%, at least 50%, at least 51%, at least 52%, at least 53%, at least 54%, at least 55%, at least 56%, at least 57%, at least 58%, at least 59%, at least 60%, at least 61%, at least 62%, at least 63%, at least 64%, at least 65%, at least 66%, at least 67%, at least 68%, at least 69%, at least 70%, at least 71%, at least 72%, at least 73%, at least 74%, at least 75%, at least 76%, at least 77%, at least 78%, at least 79%, at least 80%, at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99% at least 100%, at least 150%, at least 200%, at least 250%, at least 300%, at least 350%, at least 400%, at least 450% or at least 500% tougher and/or stronger than the meat protein of the plant-based meat substitute product.

In an embodiment, the bone portion of a plant-based meat substitute product comprises about 1%, about 2%, about 3%, about 4%, about 5%, about 6%, about 7%, about 8%, about 9%, about 10%, about 11%, about 12%, about 13%, about 14%, about 15%, about 16%, about 17%, about 18%, about 19%, about 20%, about 21%, about 22%, about 23%, about 24%, about 25%, about 26%, about 27%, about 28%, about 29%, about 30%, about 31%, about 32%, about 33%, about 34%, about 35%, about 36%, about 37%, about 38%, about 39%, about 40%, about 41%, about 42%, about 43%, about 44%, about 45%, about 46%, about 47%, about 48%, about 49%, about 50%, about 51%, about 52%, about 53%, about 54%, about 55%, about 56%, about 57%, about 58%, about 59%, about 60%, about 61%, about 62%, about 63%, about 64%, about 65%, about 66%, about 67%, about 68%, about 69%, about 70%, about 71%, about 72%, about 73%, about 74%, about 75%, about 76%, about 77%, about 78%, about 79%, about 80%, about 81%, about 82%, about 83%, about 84%, about 85%, about 86%, about 87%, about 88%, about 89%, about 90%, about 91%, about 92%, about 93%, about 94%, about 95%, about 96%, about 97%, about 98%, about 99%, about 100%, about 150%, about 200%, about 250%, about 300%, about 350%, about 400%, about 450% or about 500% tougher and/or stronger than the meat protein of the plant-based meat substitute product.

In an embodiment, the bone portion of a plant-based meat substitute product comprises no more than 1%, no more than 2%, no more than 3%, no more than 4%, no more than 5%, no more than 6%, no more than 7%, no more than 8%, no more than 9%, no more than 10%, no more than 11%, no more than 12%, no more than 13%, no more than 14%, no more than 15%, no more than 16%, no more than 17%, no more than 18%, no more than 19%, no more than 20%, no more than 21%, no more than 22%, no more than 23%, no more than 24%, no more than 25%, no more than 26%, no more than 27%, no more than 28%, no more than 29%, no more than 30%, no more than 31%, no more than 32%, no more than 33%, no more than 34%, no more than 35%, no more than 36%, no more than 37%, no more than 38%, no more than 39%, no more than 40%, no more than 41%, no more than 42%, no more than 43%, no more than 44%, no more than 45%, no more than 46%, no more than 47%, no more than 48%, no more than 49%, no more than 50%, no more than 51%, no more than 52%, no more than 53%, no more than 54%, no more than 55%, no more than 56%, no more than 57%, no more than 58%, no more than 59%, no more than 60%, no more than 61%, no more than 62%, no more than 63%, no more than 64%, no more than 65%, no more than 66%, no more than 67%, no more than 68%, no more than 69%, no more than 70%, no more than 71%, no more than 72%, no more than 73%, no more than 74%, no more than 75%, no more than 76%, no more than 77%, no more than 78%, no more than 79%, no more than 80%, no more than 81%, no more than 82%, no more than 83%, no more than 84%, no more than 85%, no more than 86%, no more than 87%, no more than 88%, no more than 89%, no more than 90%, no more than 91%, no more than 92%, no more than 93%, no more than 94%, no more than 95%, no more than 96%, no more than 97%, no more than 98%, no more than 99%, no more than 100%, no more than 150%, no more than 200%, no more than 250%, no more than 300%, no more than 350%, no more than 400%, no more than 450% or no more than 500% tougher and/or stronger than the meat protein of the plant-based meat substitute product.

In an embodiment, a plant-based meat substitute product comprises at least 1%, at least 2%, at least 3%, at least 4%, at least 5%, at least 6%, at least 7%, at least 8%, at least 9%, at least 10%, at least 11%, at least 12%, at least 13%, at least 14%, at least 15%, at least 16%, at least 17%, at least 18%, at least 19%, at least 20%, at least 21%, at least 22%, at least 23%, at least 24%, at least 25%, at least 26%, at least 27%, at least 28%, at least 29%, at least 30%, at least 31%, at least 32%, at least 33%, at least 34%, at least 35%, at least 36%, at least 37%, at least 38%, at least 39%, at least 40%, at least 41%, at least 42%, at least 43%, at least 44%, at least 45%, at least 46%, at least 47%, at least 48%, at least 49%, at least 50%, at least 51%, at least 52%, at least 53%, at least 54%, at least 55%, at least 56%, at least 57%, at least 58%, at least 59%, at least 60%, at least 61%, at least 62%, at least 63%, at least 64%, at least 65%, at least 66%, at least 67%, at least 68%, at least 69%, at least 70%, at least 71%, at least 72%, at least 73%, at least 74%, at least 75%, at least 76%, at least 77%, at least 78%, at least 79%, at least 80%, at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99% or at least 100% of a protein from a plant.

In an embodiment, a plant-based meat substitute product comprises about 1%, about 2%, about 3%, about 4%, about 5%, about 6%, about 7%, about 8%, about 9%, about 10%, about 11%, about 12%, about 13%, about 14%, about 15%, about 16%, about 17%, about 18%, about 19%, about 20%, about 21%, about 22%, about 23%, about 24%, about 25%, about 26%, about 27%, about 28%, about 29%, about 30%, about 31%, about 32%, about 33%, about 34%, about 35%, about 36%, about 37%, about 38%, about 39%, about 40%, about 41%, about 42%, about 43%, about 44%, about 45%, about 46%, about 47%, about 48%, about 49%, about 50%, about 51%, about 52%, about 53%, about 54%, about 55%, about 56%, about 57%, about 58%, about 59%, about 60%, about 61%, about 62%, about 63%, about 64%, about 65%, about 66%, about 67%, about 68%, about 69%, about 70%, about 71%, about 72%, about 73%, about 74%, about 75%, about 76%, about 77%, about 78%, about 79%, about 80%, about 81%, about 82%, about 83%, about 84%, about 85%, about 86%, about 87%, about 88%, about 89%, about 90%, about 91%, about 92%, about 93%, about 94%, about 95%, about 96%, about 97%, about 98%, about 99% or about 100% of a protein from a plant.

In an embodiment, a plant-based meat substitute product comprises no more than 1%, no more than 2%, no more than 3%, no more than 4%, no more than 5%, no more than 6%, no more than 7%, no more than 8%, no more than 9%, no more than 10%, no more than 11%, no more than 12%, no more than 13%, no more than 14%, no more than 15%, no more than 16%, no more than 17%, no more than 18%, no more than 19%, no more than 20%, no more than 21%, no more than 22%, no more than 23%, no more than 24%, no more than 25%, no more than 26%, no more than 27%, no more than 28%, no more than 29%, no more than 30%, no more than 31%, no more than 32%, no more than 33%, no more than 34%, no more than 35%, no more than 36%, no more than 37%, no more than 38%, no more than 39%, no more than 40%, no more than 41%, no more than 42%, no more than 43%, no more than 44%, no more than 45%, no more than 46%, no more than 47%, no more than 48%, no more than 49%, no more than 50%, no more than 51%, no more than 52%, no more than 53%, no more than 54%, no more than 55%, no more than 56%, no more than 57%, no more than 58%, no more than 59%, no more than 60%, no more than 61%, no more than 62%, no more than 63%, no more than 64%, no more than 65%, no more than 66%, no more than 67%, no more than 68%, no more than 69%, no more than 70%, no more than 71%, no more than 72%, no more than 73%, no more than 74%, no more than 75%, no more than 76%, no more than 77%, no more than 78%, no more than 79%, no more than 80%, no more than 81%, no more than 82%, no more than 83%, no more than 84%, no more than 85%, no more than 86%, no more than 87%, no more than 88%, no more than 89%, no more than 90%, no more than 91%, no more than 92%, no more than 93%, no more than 94%, no more than 95%, no more than 96%, no more than 97%, no more than 98%, no more than 99% or no more than 100% of a protein from a plant.

In an embodiment, a meat portion of a plant-based meat substitute product comprises at least 1%, at least 2%, at least 3%, at least 4%, at least 5%, at least 6%, at least 7%, at least 8%, at least 9%, at least 10%, at least 11%, at least 12%, at least 13%, at least 14%, at least 15%, at least 16%, at least 17%, at least 18%, at least 19%, at least 20%, at least 21%, at least 22%, at least 23%, at least 24%, at least 25%, at least 26%, at least 27%, at least 28%, at least 29%, at least 30%, at least 31%, at least 32%, at least 33%, at least 34%, at least 35%, at least 36%, at least 37%, at least 38%, at least 39%, at least 40%, at least 41%, at least 42%, at least 43%, at least 44%, at least 45%, at least 46%, at least 47%, at least 48%, at least 49%, at least 50%, at least 51%, at least 52%, at least 53%, at least 54%, at least 55%, at least 56%, at least 57%, at least 58%, at least 59%, at least 60%, at least 61%, at least 62%, at least 63%, at least 64%, at least 65%, at least 66%, at least 67%, at least 68%, at least 69%, at least 70%, at least 71%, at least 72%, at least 73%, at least 74%, at least 75%, at least 76%, at least 77%, at least 78%, at least 79%, at least 80%, at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99% or at least 100% of a protein from a plant.

In an embodiment, a meat portion of a plant-based meat substitute product comprises about 1%, about 2%, about 3%, about 4%, about 5%, about 6%, about 7%, about 8%, about 9%, about 10%, about 11%, about 12%, about 13%, about 14%, about 15%, about 16%, about 17%, about 18%, about 19%, about 20%, about 21%, about 22%, about 23%, about 24%, about 25%, about 26%, about 27%, about 28%, about 29%, about 30%, about 31%, about 32%, about 33%, about 34%, about 35%, about 36%, about 37%, about 38%, about 39%, about 40%, about 41%, about 42%, about 43%, about 44%, about 45%, about 46%, about 47%, about 48%, about 49%, about 50%, about 51%, about 52%, about 53%, about 54%, about 55%, about 56%, about 57%, about 58%, about 59%, about 60%, about 61%, about 62%, about 63%, about 64%, about 65%, about 66%, about 67%, about 68%, about 69%, about 70%, about 71%, about 72%, about 73%, about 74%, about 75%, about 76%, about 77%, about 78%, about 79%, about 80%, about 81%, about 82%, about 83%, about 84%, about 85%, about 86%, about 87%, about 88%, about 89%, about 90%, about 91%, about 92%, about 93%, about 94%, about 95%, about 96%, about 97%, about 98%, about 99% or about 100% of a protein from a plant.

In an embodiment, a meat portion of a plant-based meat substitute product comprises no more than 1%, no more than 2%, no more than 3%, no more than 4%, no more than 5%, no more than 6%, no more than 7%, no more than 8%, no more than 9%, no more than 10%, no more than 11%, no more than 12%, no more than 13%, no more than 14%, no more than 15%, no more than 16%, no more than 17%, no more than 18%, no more than 19%, no more than 20%, no more than 21%, no more than 22%, no more than 23%, no more than 24%, no more than 25%, no more than 26%, no more than 27%, no more than 28%, no more than 29%, no more than 30%, no more than 31%, no more than 32%, no more than 33%, no more than 34%, no more than 35%, no more than 36%, no more than 37%, no more than 38%, no more than 39%, no more than 40%, no more than 41%, no more than 42%, no more than 43%, no more than 44%, no more than 45%, no more than 46%, no more than 47%, no more than 48%, no more than 49%, no more than 50%, no more than 51%, no more than 52%, no more than 53%, no more than 54%, no more than 55%, no more than 56%, no more than 57%, no more than 58%, no more than 59%, no more than 60%, no more than 61%, no more than 62%, no more than 63%, no more than 64%, no more than 65%, no more than 66%, no more than 67%, no more than 68%, no more than 69%, no more than 70%, no more than 71%, no more than 72%, no more than 73%, no more than 74%, no more than 75%, no more than 76%, no more than 77%, no more than 78%, no more than 79%, no more than 80%, no more than 81%, no more than 82%, no more than 83%, no more than 84%, no more than 85%, no more than 86%, no more than 87%, no more than 88%, no more than 89%, no more than 90%, no more than 91%, no more than 92%, no more than 93%, no more than 94%, no more than 95%, no more than 96%, no more than 97%, no more than 98%, no more than 99% or no more than 100% of a protein from a plant.

In an embodiment, the meat substitute or other use of a plant-based protein concentrate created by a manufacturing process disclosed herein includes at least 0.00001%, at least 0.0001%, at least 0.001%, at least 0.01%, at least 0.1%, at least 1%, at least 2%, at least 3%, at least 4%, at least 5%, at least 6%, at least 7%, at least 8%, at least 9%, at least 10 or more by weight of a flavoring agent. In an embodiment, the meat substitute or other use of a plant-based protein concentrate includes about about 0.0001%, about 0.001%, about 0.01%, about 0.1%, about 1%, about 2%, about 3%, about 4%, about 5%, about 6%, about 7%, about 8%, about 9%, about 10 or more by weight of a flavoring agent. In an embodiment, the meat substitute or other use of a plant-based protein concentrate includes no more than 0.00001%, no more than 0.0001%, no more than 0.001%, no more than 0.01%, no more than 0.1%, no more than 1%, no more than 2%, no more than 3%, no more than 4%, no more than 5%, no more than 6%, no more than 7%, no more than 8%, no more than 9%, no more than 10 or more by weight of a flavoring agent.

In one embodiment, a meat substitute product created by a manufacturing process disclosed herein is provided that appears pink in color without the addition of vegetable dyes. In an embodiment this meat substitute product is pink in color without the addition of vegetable dyes is prepared from a red seaweed. In an embodiment, a meat substitute and/or a plant-based meat substitute product, includes a coloring agent, such that when it is cooked, it takes on a brownish color on the outside and a pinkish to reddish or reddish-purple color on the inside. In a further embodiment, when the meat substitute and/or plant-based meat substitute product is cooked, it takes on a brownish color on the outside and throughout most if not all of the meat substitute product and/or plant-based meat substitute product. In another embodiment of the present invention, a food product is provided where the gel and/or tensile strength of the meat substitute is increased by the addition of a seaweed protein concentrate. In another embodiment of the present invention, a meat substitute is provided where the taste of a food product is enhanced by the addition of a seaweed protein concentrate. In a further embodiment of the present invention, a meat substitute is produced where the fat-binding capacity of the meat substitute is enhanced by the addition of a seaweed protein concentrate. In another embodiment of the present invention, the addition of a seaweed protein concentrate contributes to a combination of improved attributes among the aspects of color, color change, flavor, gel strength, solubility, fat-binding capacity, and/or nutrition of a meat substitute product.

In an embodiment, the plant-based meat substitute or other plant-based protein product created by a manufacturing process disclosed herein includes at least 0.00001%, at least 0.0001%, at least 0.001%, at least 0.01%, at least 0.1%, at least 1%, at least 2%, at least 3%, at least 4%, at least 5%, at least 6%, at least 7%, at least 8%, at least 9%, at least 10 or more by weight of a heme-containing protein and/or an iron salt. In an embodiment, the plant-based meat substitute product or other plant-based protein product includes about 0.00001%, about 0.0001%, about 0.001%, about 0.01%, about 0.1%, about 1%, about 2%, about 3%, about 4%, about 5%, about 6%, about 7%, about 8%, about 9%, about 10 or more by weight of a heme-containing protein and/or an iron salt. In an embodiment, the plant-based meat substitute product or other plant-based protein product includes no more than 0.00001%, no more than 0.0001%, no more than 0.001%, no more than 0.01%, no more than 0.1%, no more than 1%, no more than 2%, no more than 3%, no more than 4%, no more than 5%, no more than 6%, no more than 7%, no more than 8%, no more than 9%, no more than 10 or more by weight of a heme-containing protein and/or an iron salt.

In another embodiment, the meat substitute created by a manufacturing process disclosed herein containing a seaweed protein concentrate or another plant-based protein concentrate has a color that is at least 1%, at least 2%, at least 3%, at least 4%, at least 5%, at least 6%, at least 7%, at least 8%, at least 9%, at least 10%, at least 11%, at least 12%, at least 13%, at least 14%, at least 15%, at least 16%, at least 17%, at least 18%, at least 19%, at least 20%, at least 21%, at least 22%, at least 23%, at least 24%, at least 25%, at least 26%, at least 27%, at least 28%, at least 29%, at least 30%, at least 31%, at least 32%, at least 33%, at least 34%, at least 35%, at least 36%, at least 37%, at least 38%, at least 39%, at least 40%, at least 41%, at least 42%, at least 43%, at least 44%, at least 45%, at least 46%, at least 47%, at least 48%, at least 49%, at least 50%, at least 51%, at least 52%, at least 53%, at least 54%, at least 55%, at least 56%, at least 57%, at least 58%, at least 59%, at least 60%, at least 61%, at least 62%, at least 63%, at least 64%, at least 65%, at least 66%, at least 67%, at least 68%, at least 69%, at least 70%, at least 71%, at least 72%, at least 73%, at least 74%, at least 75%, at least 76%, at least 77%, at least 78%, at least 79%, at least 80%, at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99% or at least 100% the same as that of a meat from an animal or other product that is produced from a meat.

In an embodiment, a product that utilizes or uses a protein concentrate as disclosed herein includes be a protein bar, a flavored protein concentrate that is in a liquid form or can be resolubilized, a baked good or a breakfast cereal.

In another embodiment, the meat substitute product containing a seaweed protein concentrate or another product that includes a plant-based protein concentrate created by a manufacturing process disclosed herein has a color that is about 1%, about 2%, about 3%, about 4%, about 5%, about 6%, about 7%, about 8%, about 9%, about 10%, about 11%, about 12%, about 13%, about 14%, about 15%, about 16%, about 17%, about 18%, about 19%, about 20%, about 21%, about 22%, about 23%, about 24%, about 25%, about 26%, about 27%, about 28%, about 29%, about 30%, about 31%, about 32%, about 33%, about 34%, about 35%, about 36%, about 37%, about 38%, about 39%, about 40%, about 41%, about 42%, about 43%, about 44%, about 45%, about 46%, about 47%, about 48%, about 49%, about 50%, about 51%, about 52%, about 53%, about 54%, about 55%, about 56%, about 57%, about 58%, about 59%, about 60%, about 61%, about 62%, about 63%, about 64%, about 65%, about 66%, about 67%, about 68%, about 69%, about 70%, about 71%, about 72%, about 73%, about 74%, about 75%, about 76%, about 77%, about 78%, about 79%, about 80%, about 81%, about 82%, about 83%, about 84%, about 85%, about 86%, about 87%, about 88%, about 89%, about 90%, about 91%, about 92%, about 93%, about 94%, about 95%, about 96%, about 97%, about 98%, about 99% or about 100% the same as that of a meat from an animal.

In another embodiment, the meat substitute product containing a seaweed protein concentrate or another product that includes a plant-based protein concentrate created by a manufacturing process disclosed herein has a color that is no more than 1%, no more than 2%, no more than 3%, no more than 4%, no more than 5%, no more than 6%, no more than 7%, no more than 8%, no more than 9%, no more than 10%, no more than 11%, no more than 12%, no more than 13%, no more than 14%, no more than 15%, no more than 16%, no more than 17%, no more than 18%, no more than 19%, no more than 20%, no more than 21%, no more than 22%, no more than 23%, no more than 24%, no more than 25%, no more than 26%, no more than 27%, no more than 28%, no more than 29%, no more than 30%, no more than 31%, no more than 32%, no more than 33%, no more than 34%, no more than 35%, no more than 36%, no more than 37%, no more than 38%, no more than 39%, no more than 40%, no more than 41%, no more than 42%, no more than 43%, no more than 44%, no more than 45%, no more than 46%, no more than 47%, no more than 48%, no more than 49%, no more than 50%, no more than 51%, no more than 52%, no more than 53%, no more than 54%, no more than 55%, no more than 56%, no more than 57%, no more than 58%, no more than 59%, no more than 60%, no more than 61%, no more than 62%, no more than 63%, no more than 64%, no more than 65%, no more than 66%, no more than 67%, no more than 68%, no more than 69%, no more than 70%, no more than 71%, no more than 72%, no more than 73%, no more than 74%, no more than 75%, no more than 76%, no more than 77%, no more than 78%, no more than 79%, no more than 80%, no more than 81%, no more than 82%, no more than 83%, no more than 84%, no more than 85%, no more than 86%, no more than 87%, no more than 88%, no more than 89%, no more than 90%, no more than 91%, no more than 92%, no more than 93%, no more than 94%, no more than 95%, no more than 96%, no more than 97%, no more than 98%, no more than 99% or no more than 100% the same as that of a meat from an animal.

In an embodiment, the meat substitute product or other product that includes a plant-based protein concentrate created by a manufacturing process disclosed herein comprises about 5% by weight of protein. In a further embodiment, the meat substitute provided herein comprise at least 1%, at least 2%, at least 3%, at least 4%, at least 5%, at least 6%, at least 7%, at least 8%, at least 9%, at least 10%, at least 11%, at least 12%, at least 13%, at least 14%, at least 15%, at least 16%, at least at least 25%, at least 26%, at least 27%, at least 28%, at least 29%, at least 30%, at least 31%, at least 32%, at least 33%, at least 34%, at least 35%, at least 36%, at least 37%, at least 38%, at least 39%, at least 40%, at least 41%, at least 42%, at least 43%, at least 44%, at least 45%, at least 46%, at least 47%, at least 48%, at least 49%, at least 50%, at least 51%, at least 52%, at least 53%, at least 54%, at least 55%, at least 56%, at least 57%, at least 58%, at least 59%, at least 60%, at least 61%, at least 62%, at least 63%, at least 64%, at least 65%, at least 66%, at least 67%, at least 68%, at least 69%, at least 70%, at least 71%, at least 72%, at least 73%, at least 74%, at least 75%, at least 76%, at least 77%, at least 78%, at least 79%, at least 80%, at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99% or at least 100% weight by protein of the meat substitute product.

In a further embodiment, the meat substitute product or another product that includes a plant-based protein concentrate created by a manufacturing process disclosed herein comprise about 1%, about 2%, about 3%, about 4%, about 5%, about 6%, about 7%, about 8%, about 9%, about 10%, about 11%, about 12%, about 13%, about 14%, about 15%, about 16%, about 17%, about 18%, about 19%, about 20%, about 21%, about 22%, about 23%, about 24%, about 25%, about 26%, about 27%, about 28%, about 29%, about 30%, about 31%, about 32%, about 33%, about 34%, about 35%, about 36%, about 37%, about 38%, about 39%, about 40%, about 41%, about 42%, about 43%, about 44%, about 45%, about 46%, about 47%, about 48%, about 49%, about 50%, about 51%, about 52%, about 53%, about 54%, about 55%, about 56%, about 57%, about 58%, about 59%, about 60%, about 61%, about 62%, about 63%, about 64%, about 65%, about 66%, about 67%, about 68%, about 69%, about 70%, about 71%, about 72%, about 73%, about 74%, about 75%, about 76%, about 77%, about 78%, about 79%, about 80%, about 81%, about 82%, about 83%, about 84%, about 85%, about 86%, about 87%, about 88%, about 89%, about 90%, about 91%, about 92%, about 93%, about 94%, about 95%, about 96%, about 97%, about 98%, about 99% or about 100% weight by protein of the meat substitute product.

In a further embodiment, the meat substitute product or another product that includes a plant-based protein concentrate created by a manufacturing process disclosed herein comprise no more than 1%, no more than 2%, no more than 3%, no more than 4%, no more than 5%, no more than 6%, no more than 7%, no more than 8%, no more than 9%, no more than 10%, no more than 11%, no more than 12%, no more than 13%, no more than 14%, no more than 15%, no more than 16%, no more than 17%, no more than 18%, no more than 19%, no more than 20%, no more than 21%, no more than 22%, no more than 23%, no more than 24%, no more than 25%, no more than 26%, no more than 27%, no more than 28%, no more than 29%, no more than 30%, no more than 31%, no more than 32%, no more than 33%, no more than 34%, no more than 35%, no more than 36%, no more than 37%, no more than 38%, no more than 39%, no more than 40%, no more than 41%, no more than 42%, no more than 43%, no more than 44%, no more than 45%, no more than 46%, no more than 47%, no more than 48%, no more than 49%, no more than 50%, no more than 51%, no more than 52%, no more than 53%, no more than 54%, no more than 55%, no more than 56%, no more than 57%, no more than 58%, no more than 59%, no more than 60%, no more than 61%, no more than 62%, no more than 63%, no more than 64%, no more than 65%, no more than 66%, no more than 67%, no more than 68%, no more than 69%, no more than 70%, no more than 71%, no more than 72%, no more than 73%, no more than 74%, no more than 75%, no more than 76%, no more than 77%, no more than 78%, no more than 79%, no more than 80%, no more than 81%, no more than 82%, no more than 83%, no more than 84%, no more than 85%, no more than 86%, no more than 87%, no more than 88%, no more than 89%, no more than 90%, no more than 91%, no more than 92%, no more than 93%, no more than 94%, no more than 95%, no more than 96%, no more than 97%, no more than 98%, no more than 99% or no more than 100% weight by protein of the meat substitute product.

In an embodiment, a protein-based meat substitute product or another product that includes a plant-based protein concentrate created by a manufacturing process disclosed herein is comprised of a meat substitute that is comprised of 1% to 90%, 0.1% to 1%, 0.2% to 1%, 0.3% to 1%. 0.4% to 1%, to 1%, 0.6% to 1%, 0.7% to 1%, 0.8% to 1%, 0.9% to 1%, 0.1% to 2, 0.5% to 2.5%, 1% to 5%, 2% to 25%, 3% to 20%, 5% to 50%, 4% to 40%, 3% to 10%, 1% to 3%, 0.1% to 2% or any other combination of concentrations between about 1% to about 90% of a seaweed protein concentrate or other plant-based protein concentrate, about 1% to about 90% of a non-seaweed protein concentrate or other plant-based protein concentrate, about 0% to about 30% of carbohydrate, and about 1% to 30% lipid.

In an embodiment, a plant-based meat substitute product or another product that includes a plant-based protein concentrate created by a manufacturing process disclosed herein is comprised of a meat substitute product that is comprised of at least 1%, at least 2%, at least 3%, at least 4%, at least 5%, at least 6%, at least 7%, at least 8%, at least 9%, at least 10%, at least 11%, at least 12%, at least 13%, at least 14%, at least 15%, at least 16%, at least 17%, at least 18%, at least 19%, at least 20%, at least 21%, at least 22%, at least 23%, at least 24%, at least 25%, at least 26%, at least 27%, at least 28%, at least 29%, at least 30%, at least 31%, at least 32%, at least 33%, at least 34%, at least 35%, at least 36%, at least 37%, at least 38%, at least 39%, at least 40%, at least 41%, at least 42%, at least 43%, at least 44%, at least 45%, at least 46%, at least 47%, at least 48%, at least 49%, at least 50%, at least 51%, at least 52%, at least 53%, at least 54%, at least 55%, at least 56%, at least 57%, at least 58%, at least 59%, at least 60%, at least 61%, at least 62%, at least 63%, at least 64%, at least 65%, at least 66%, at least 67%, at least 68%, at least 69%, at least 70%, at least 71%, at least 72%, at least 73%, at least 74%, at least 75%, at least 76%, at least 77%, at least 78%, at least 79%, at least 80%, at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99% or at least 100% seaweed protein concentrate or a plant-based protein concentrate.

In an embodiment, a plant-based meat substitute product or another product that includes a plant-based protein concentrate created by a manufacturing process disclosed herein is comprised of a meat substitute or other product that is comprised of about 1%, about 2%, about 3%, about 4%, about 5%, about 6%, about 7%, about 8%, about 9%, about 10%, about 11%, about 12%, about 13%, about 14%, about 15%, about 16%, about 17%, about 18%, about 19%, about 20%, about 21%, about 22%, about 23%, about 24%, about 25%, about 26%, about 27%, about 28%, about 29%, about 30%, about 31%, about 32%, about 33%, about 34%, about 35%, about 36%, about 37%, about 38%, about 39%, about 40%, about 41%, about 42%, about 43%, about 44%, about 45%, about 46%, about 47%, about 48%, about 49%, about 50%, about 51%, about 52%, about 53%, about 54%, about 55%, about 56%, about 57%, about 58%, about 59%, about 60%, about 61%, about 62%, about 63%, about 64%, about 65%, about 66%, about 67%, about 68%, about 69%, about 70%, about 71%, about 72%, about 73%, about 74%, about 75%, about 76%, about 77%, about 78%, about 79%, about 80%, about 81%, about 82%, about 83%, about 84%, about 85%, about 86%, about 87%, about 88%, about 89%, about 90%, about 91%, about 92%, about 93%, about 94%, about 95%, about 96%, about 97%, about 98%, about 99% or about 100% seaweed protein concentrate or another plant-based protein concentrate.

In an embodiment, a plant-based meat substitute product or another product that includes a plant-based protein concentrate created by a manufacturing process disclosed herein is comprised of a meat substitute product or other product that is comprised of no more than 1%, no more than 2%, no more than 3%, no more than 4%, no more than 5%, no more than 6%, no more than 7%, no more than 8%, no more than 9%, no more than 10%, no more than 11%, no more than 12%, no more than 13%, no more than 14%, no more than 15%, no more than 16%, no more than 17%, no more than 18%, no more than 19%, no more than 20%, no more than 21%, no more than 22%, no more than 23%, no more than 24%, no more than 25%, no more than 26%, no more than 27%, no more than 28%, no more than 29%, no more than 30%, no more than 31%, no more than 32%, no more than 33%, no more than 34%, no more than 35%, no more than 36%, no more than 37%, no more than 38%, no more than 39%, no more than 40%, no more than 41%, no more than 42%, no more than 43%, no more than 44%, no more than 45%, no more than 46%, no more than 47%, no more than 48%, no more than 49%, no more than 50%, no more than 51%, no more than 52%, no more than 53%, no more than 54%, no more than 55%, no more than 56%, no more than 57%, no more than 58%, no more than 59%, no more than 60%, no more than 61%, no more than 62%, no more than 63%, no more than 64%, no more than 65%, no more than 66%, no more than 67%, no more than 68%, no more than 69%, no more than 70%, no more than 71%, no more than 72%, no more than 73%, no more than 74%, no more than 75%, no more than 76%, no more than 77%, no more than 78%, no more than 79%, no more than 80%, no more than 81%, no more than 82%, no more than 83%, no more than 84%, no more than 85%, no more than 86%, no more than 87%, no more than 88%, no more than 89%, no more than 90%, no more than 91%, no more than 92%, no more than 93%, no more than 94%, no more than 95%, no more than 96%, no more than 97%, no more than 98%, no more than 99% or no more than 100% seaweed protein concentrate or another plant-based protein concentrate.

In an embodiment, a plant-based meat substitute product or other product is comprised of a meat substitute product or other form of a plant-based protein concentrate that is comprised of at least 1%, at least 2%, at least 3%, at least 4%, at least 5%, at least 6%, at least 7%, at least 8%, at least 9%, at least 10%, at least 11%, at least 12%, at least 13%, at least 14%, at least 15%, at least 16%, at least at least 25%, at least 26%, at least 27%, at least 28%, at least 29%, at least 30%, at least 31%, at least 32%, at least 33%, at least 34%, at least 35%, at least 36%, at least 37%, at least 38%, at least 39%, at least 40%, at least 41%, at least 42%, at least 43%, at least 44%, at least 45%, at least 46%, at least 47%, at least 48%, at least 49%, at least 50%, at least 51%, at least 52%, at least 53%, at least 54%, at least 55%, at least 56%, at least 57%, at least 58%, at least 59%, at least 60%, at least 61%, at least 62%, at least 63%, at least 64%, at least 65%, at least 66%, at least 67%, at least 68%, at least 69%, at least 70%, at least 71%, at least 72%, at least 73%, at least 74%, at least 75%, at least 76%, at least 77%, at least 78%, at least 79%, at least 80%, at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99% or at least 100% of a non- seaweed plant protein concentrate or other plant-based protein concentrate.

In an embodiment, a plant-based meat substitute product or other product is comprised of a meat substitute product created by a manufacturing process disclosed herein is comprised of about 1%, about 2%, about 3%, about 4%, about 5%, about 6%, about 7%, about 8%, about 9%, about 10%, about 11%, about 12%, about 13%, about 14%, about 15%, about 16%, about 17%, about 18%, about 19%, about 20%, about 21%, about 22%, about 23%, about 24%, about 25%, about 26%, about 27%, about 28%, about 29%, about 30%, about 31%, about 32%, about 33%, about 34%, about 35%, about 36%, about 37%, about 38%, about 39%, about 40%, about 41%, about 42%, about 43%, about 44%, about 45%, about 46%, about 47%, about 48%, about 49%, about 50%, about 51%, about 52%, about 53%, about 54%, about 55%, about 56%, about 57%, about 58%, about 59%, about 60%, about 61%, about 62%, about 63%, about 64%, about 65%, about 66%, about 67%, about 68%, about 69%, about 70%, about 71%, about 72%, about 73%, about 74%, about 75%, about 76%, about 77%, about 78%, about 79%, about 80%, about 81%, about 82%, about 83%, about 84%, about 85%, about 86%, about 87%, about 88%, about 89%, about 90%, about 91%, about 92%, about 93%, about 94%, about 95%, about 96%, about 97%, about 98%, about 99% or about 100% of a non-seaweed plant protein concentrate or other plant-based concentrate.

In an embodiment, a plant-based meat substitute product or other product is comprised of a meat substitute product created by a manufacturing process disclosed herein is comprised of no more than 1%, no more than 2%, no more than 3%, no more than 4%, no more than 5%, no more than 6%, no more than 7%, no more than 8%, no more than 9%, no more than 10%, no more than 11%, no more than 12%, no more than 13%, no more than 14%, no more than 15%, no more than 16%, no more than 17%, no more than 18%, no more than 19%, no more than 20%, no more than 21%, no more than 22%, no more than 23%, no more than 24%, no more than 25%, no more than 26%, no more than 27%, no more than 28%, no more than 29%, no more than 30%, no more than 31%, no more than 32%, no more than 33%, no more than 34%, no more than 35%, no more than 36%, no more than 37%, no more than 38%, no more than 39%, no more than 40%, no more than 41%, no more than 42%, no more than 43%, no more than 44%, no more than 45%, no more than 46%, no more than 47%, no more than 48%, no more than 49%, no more than 50%, no more than 51%, no more than 52%, no more than 53%, no more than 54%, no more than 55%, no more than 56%, no more than 57%, no more than 58%, no more than 59%, no more than 60%, no more than 61%, no more than 62%, no more than 63%, no more than 64%, no more than 65%, no more than 66%, no more than 67%, no more than 68%, no more than 69%, no more than 70%, no more than 71%, no more than 72%, no more than 73%, no more than 74%, no more than 75%, no more than 76%, no more than 77%, no more than 78%, no more than 79%, no more than 80%, no more than 81%, no more than 82%, no more than 83%, no more than 84%, no more than 85%, no more than 86%, no more than 87%, no more than 88%, no more than 89%, no more than 90%, no more than 91%, no more than 92%, no more than 93%, no more than 94%, no more than 95%, no more than 96%, no more than 97%, no more than 98%, no more than 99% or no more than 100% of a non- seaweed plant protein concentrate or other plant-based concentrate.

In an In an embodiment, the protein created by a manufacturing process disclosed herein may be comprised of polypeptide molecules having an identical amino acid sequence, or of a mixture of polypeptide molecules having at least 2 different amino acid sequences. In a further embodiment, the protein created by a manufacturing process disclosed herein may be comprised of naturally occurring amino acids or non-naturally occurring amino acids. In a further embodiment, the protein concentrate created by a manufacturing process disclosed herein is used to create the meat substitute product that can be derived and/or obtained from one type of seaweed or from two or more types of seaweed. In another embodiment, the protein concentrate created by a manufacturing process disclosed herein is used to create the meat substitute product can be derived and/or obtained from a seaweed and a one or more other plant sources, including wheat, soy and pea. In another embodiment, the protein concentrate created by a manufacturing process disclosed herein is used to create the meat substitute product can be derived and/or obtained from a seaweed and a protein concentrate source wherein the protein is manufactured synthetically using natural or non-natural amino acids. In some embodiments, the protein concentrate used to create the meat substitute product can be derived and/or obtained from a seaweed and an animal source, including a cow, a sheep, a goat, a pig, a duck, or an ostrich. In another embodiment, the protein concentrate created by a manufacturing process disclosed herein is used to create the meat substitute product can be derived and/or obtained from a seaweed and an animal source, including a fish, a shellfish, or a crustacean. In some embodiments, the protein is not derived from a plant source but is identical or similar to protein found in a plant source, for example, the protein is synthetically or biosynthetically generated but comprises polypeptide molecules that have an identical or similar amino acid sequence as polypeptide molecules found in an animal source.

In an embodiment, a protein concentrate is resuspended in a solvent. In another embodiment, a solvent is used to wash a protein concentrate. In an embodiment, a solvent is an alcohol. In a further embodiment, an alcohol solvent is selected from Ter-Amyl alcohol, Benzyl alcohol, 1,4-Butanediol, 1,2,4-Butanetriol, Butanol, 1-Butanol, 2-Butanol, Tert-Butyl alcohol, Denatured alcohol, Di(propylene glycol) methyl ether, Diethylene glycol, Ethanol, Ethylene glycol, 2-Ethylhexanol, Furfuryl alcohol, Glycerol, Isobutanol, Isopropyl alcohol, Methanol, 2-(2-Methoxyethoxy)ethanol, 2-Methyl-1-butanol, 2-Methyl-1-pentanol, 3-Methyl-2-butanol, Neopentyl alcohol, 2-Pentanol, 1,3-Propanediol, 1-Propanol, Propylene glycol or Propylene glycol methyl ether.

In a further embodiment, the solvent is a non-polar solvent or a highly non-polar solvent. In another embodiment, the non-polar solvent or a highly non-polar solvent is a petroleum ether, a hexane, a toluene, a diethyl ether, 1,4-dioxane, ethyl acetate, acetic acid, n-butanol, isopropanol, n-propanol, ethanol, formic acid, water, a methyl t-butyl ether. In an embodiment, the non-polar solvent of a highly non-polar solvent is used to remove lipids by “defatting” the plant proteins.

In an embodiment, the ratio of protein concentrate created by a manufacturing process disclosed herein that is derived and/or obtained from a seaweed versus derived and/or obtained from a non-seaweed source (e.g. other plant, synthetically produced or animal) is 1:99, 2:98, 3:97, 4:96, 5:95, 6:94, 7:93, 8:92, 9:91, 10:90, 11:89, 12:88, 13:87, 14:86, 15:85, 16:84, 17:83, 18:82, 19:81, 20:80, 21:79, 22:78, 23:77, 24:76, 25:75, 26:74, 27:73, 28:72, 29:71, 30:70, 31:69, 32:68, 33:67, 34:66, 35:65, 36:64, 37:63, 38:62, 39:61, 40:60, 41:59, 42:58, 43:87, 44:56, 45:55, 46:54, 47:53, 48:52, 49:51, 50:50, 51:49, 52:48, 53:47, 54:46, 55:45, 56:44, 57:43, 58:42, 59:41, 60:40, 61:39, 62:38, 63:37, 64:36, 65:35, 66:34, 67:33, 68:32, 69:31, 70:30, 71, 29, 72:28, 73:27, 74:26, 75:25, 76:24, 77:23, 78:22, 79:21, 80:20, 81:19, 82:18, 83:17, 84:16, 85:15, 84:16, 85:15, 86:14, 87:13, 88:12, 89:11, 90:10, 91:9, 92:8, 93:7, 94:6, 95:5, 96:4, 97:3, 98:2 or 99:1.

In some embodiments, the meat substitute or other product contains a protein concentrate created by a manufacturing process disclosed herein is between about 10% and about 90%, between about 20% and about 80%, between about 30% and about 70%, between about 34% and about 50%, between about 30% and about 60%, between about 30% and about 50%, between about 40% and about 50%, between about 60% and about 80%, or between about 70% and about 90% of the weight of the meat substitute. In some embodiments, the meat substitute comprises between about 5% and about 45%, between about 10% and about 40%, between about 10% and about 25%, between about 15% and about 35%, between about 15% and about 30%, between about 15% and about 25%, between about 10% and about 25%, between about 20% and about 25%, between about 30% and about 40%, between about 35% and about 45%, between about 5% and about 65%, between about 10% and about 60%, or between about 15% and about 55% by weight of protein.

In another embodiment, the plant-based meat substitute product created by a manufacturing process disclosed herein is comprised of a meat substitute product that is derived and/or obtained from a red seaweed (Rhodophyta). In an embodiment, the red seaweed is Gracilaria, Porphyra, Pyropia, Kappaficus, Eucheumaa, or Palmaria. In a further embodiment, the plant-based meat substitute product is derived from a brown seaweed (Phaeophyta). In another embodiment, the brown seaweed is Undaria, Alaria, Laminaria, Sargassum, or Saccharina. In another embodiment, the seaweed protein is derived from a green seaweed (Chlorophyta). In a further embodiment, the green seaweed is Ulva or Monostroma.

In an embodiment, the plant-based meat substitute product or other product created by a manufacturing process disclosed herein is to replace a meat from an animal or animal derived protein concentrate. In a further embodiment, the meat or animal derived protein concentrate to be replaced is from a cow, a goat, a sheep, a pig or a bird. In an embodiment, the plant-based meat substitute product is to replace a seafood. In an embodiment, the meat to be replaced is from a fish, a shrimp, a lobster, a crab, a squid, an octopus or an eel. In an embodiment, the plant-based substitute product is to replace a cheese. In an embodiment, the cheese to be replaced is from a cow, a goat or a sheep. In an embodiment, the plant-based substitute product is to replace an egg. In an embodiment, the plant-based meat substitute product the egg to be replaced is from a chicken, a turkey or an ostrich. In an embodiment, the plant-based substitute product is to replace milk. In an embodiment, the milk to be replaced is from a cow, a goat or a sheep.

In another embodiment, the plant-based meat substitute product or other product created by a manufacturing process disclosed herein includes at least 1%, at least 2%, at least 3%, at least 4%, at least 5%, at least 6%, at least 7%, at least 8%, at least 9%, at least 10%, at least 11%, at least 12%, at least 13%, at least 14%, at least 15%, at least 16%, at least 17%, at least 18%, at least 19%, at least 20%, at least 21%, at least 22%, at least 23%, at least 24%, at least 25%, at least 26%, at least 27%, at least 28%, at least 29%, at least 30%, at least 31%, at least 32%, at least 33%, at least 34%, at least 35%, at least 36%, at least 37%, at least 38%, at least 39%, at least 40%, at least 41%, at least 42%, at least 43%, at least 44%, at least 45%, at least 46%, at least 47%, at least 48%, at least 49%, at least 50%, at least 51%, at least 52%, at least 53%, at least 54%, at least 55%, at least 56%, at least 57%, at least 58%, at least 59%, at least 60%, at least 61%, at least 62%, at least 63%, at least 64%, at least 65%, at least 66%, at least 67%, at least 68%, at least 69%, at least 70%, at least 71%, at least 72%, at least 73%, at least 74%, at least 75%, at least 76%, at least 77%, at least 78%, at least 79%, at least 80%, at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99% or at least 100% by weight a meat substitute or a concentrate from a plant.

In another embodiment, the plant-based meat substitute product or other product created by a manufacturing process disclosed herein includes about 1%, about 2%, about 3%, about 4%, about 5%, about 6%, about 7%, about 8%, about 9%, about 10%, about 11%, about 12%, about 13%, about 14%, about 15%, about 16%, about 17%, about 18%, about 19%, about 20%, about 21%, about 22%, about 23%, about 24%, about 25%, about 26%, about 27%, about 28%, about 29%, about 30%, about 31%, about 32%, about 33%, about 34%, about 35%, about 36%, about 37%, about 38%, about 39%, about 40%, about 41%, about 42%, about 43%, about 44%, about 45%, about 46%, about 47%, about 48%, about 49%, about 50%, about 51%, about 52%, about 53%, about 54%, about 55%, about 56%, about 57%, about 58%, about 59%, about 60%, about 61%, about 62%, about 63%, about 64%, about 65%, about 66%, about 67%, about 68%, about 69%, about 70%, about 71%, about 72%, about 73%, about 74%, about 75%, about 76%, about 77%, about 78%, about 79%, about 80%, about 81%, about 82%, about 83%, about 84%, about 85%, about 86%, about 87%, about 88%, about 89%, about 90%, about 91%, about 92%, about 93%, about 94%, about 95%, about 96%, about 97%, about 98%, about 99% or about 100% by weight of a meat substitute or concentrate from a plant.

In another embodiment, the plant-based meat substitute product or other product created by a manufacturing process disclosed herein includes no more than 1%, no more than 2%, no more than 3%, no more than 4%, no more than 5%, no more than 6%, no more than 7%, no more than 8%, no more than 9%, no more than 10%, no more than 11%, no more than 12%, no more than 13%, no more than 14%, no more than 15%, no more than 16%, no more than 17%, no more than 18%, no more than 19%, no more than 20%, no more than 21%, no more than 22%, no more than 23%, no more than 24%, no more than 25%, no more than 26%, no more than 27%, no more than 28%, no more than 29%, no more than 30%, no more than 31%, no more than 32%, no more than 33%, no more than 34%, no more than 35%, no more than 36%, no more than 37%, no more than 38%, no more than 39%, no more than 40%, no more than 41%, no more than 42%, no more than 43%, no more than 44%, no more than 45%, no more than 46%, no more than 47%, no more than 48%, no more than 49%, no more than 50%, no more than 51%, no more than 52%, no more than 53%, no more than 54%, no more than 55%, no more than 56%, no more than 57%, no more than 58%, no more than 59%, no more than 60%, no more than 61%, no more than 62%, no more than 63%, no more than 64%, no more than 65%, no more than 66%, no more than 67%, no more than 68%, no more than 69%, no more than 70%, no more than 71%, no more than 72%, no more than 73%, no more than 74%, no more than 75%, no more than 76%, no more than 77%, no more than 78%, no more than 79%, no more than 80%, no more than 81%, no more than 82%, no more than 83%, no more than 84%, no more than 85%, no more than 86%, no more than 87%, no more than 88%, no more than 89%, no more than 90%, no more than 91%, no more than 92%, no more than 93%, no more than 94%, no more than 95%, no more than 96%, no more than 97%, no more than 98%, no more than 99% or no more than 100% by weight of a meat substitute or concentrate from a plant.

In another embodiment, the meat substitute containing a seaweed protein concentrate created by a manufacturing process disclosed herein has a tensile strength that is at least 1%, at least 2%, at least 3%, at least 4%, at least 5%, at least 6%, at least 7%, at least 8%, at least 9%, at least 10%, at least 11%, at least 12%, at least 13%, at least 14%, at least 15%, at least 16%, at least 17%, at least 18%, at least 19%, at least 20%, at least 21%, at least 22%, at least 23%, at least 24%, at least 25%, at least 26%, at least 27%, at least 28%, at least 29%, at least 30%, at least 31%, at least 32%, at least 33%, at least 34%, at least 35%, at least 36%, at least 37%, at least 38%, at least 39%, at least 40%, at least 41%, at least 42%, at least 43%, at least 44%, at least 45%, at least 46%, at least 47%, at least 48%, at least 49%, at least 50%, at least 51%, at least 52%, at least 53%, at least 54%, at least 55%, at least 56%, at least 57%, at least 58%, at least 59%, at least 60%, at least 61%, at least 62%, at least 63%, at least 64%, at least 65%, at least 66%, at least 67%, at least 68%, at least 69%, at least 70%, at least 71%, at least 72%, at least 73%, at least 74%, at least 75%, at least 76%, at least 77%, at least 78%, at least 79%, at least 80%, at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99% or at least 100% greater than a meat substitute containing a protein concentrate from another plant, including wheat, grains (including, quinoa, barley, bulgur, farro and kasha), pulse (including, lentils, dry beans, dry broad beans, dry peas, chickpeas, cow peas, pigeon peas, Bambara beans, vetches, lupins, pulses nes), cereals (including, pearl millet, proso millet, sorghum, oats, rye, teff, triticale, finger millet, fonio, foxtail millet, kodo millet, Japanese millet, Job's Tears), pseudograins (including, amaranth, breadnut, buckwheat, chia, cockscomb, pitseed goosefoot, kaniwa, wattleseed) legumes (including, alfalfa, clover, peas, beans, lupins, mesquite, carob, soybeans, peanuts, tamarind), rice, mung beans and/or corn.

In another embodiment, the meat substitute containing a seaweed protein concentrate created by a manufacturing process disclosed herein has a tensile strength that is about 1%, about 2%, about 3%, about 4%, about 5%, about 6%, about 7%, about 8%, about 9%, about 10%, about 11%, about 12%, about 13%, about 14%, about 15%, about 16%, about 17%, about 18%, about 19%, about 20%, about 21%, about 22%, about 23%, about 24%, about 25%, about 26%, about 27%, about 28%, about 29%, about 30%, about 31%, about 32%, about 33%, about 34%, about 35%, about 36%, about 37%, about 38%, about 39%, about 40%, about 41%, about 42%, about 43%, about 44%, about 45%, about 46%, about 47%, about 48%, about 49%, about 50%, about 51%, about 52%, about 53%, about 54%, about 55%, about 56%, about 57%, about 58%, about 59%, about 60%, about 61%, about 62%, about 63%, about 64%, about 65%, about 66%, about 67%, about 68%, about 69%, about 70%, about 71%, about 72%, about 73%, about 74%, about 75%, about 76%, about 77%, about 78%, about 79%, about 80%, about 81%, about 82%, about 83%, about 84%, about 85%, about 86%, about 87%, about 88%, about 89%, about 90%, about 91%, about 92%, about 93%, about 94%, about 95%, about 96%, about 97%, about 98%, about 99% or about 100% greater than a meat substitute containing a protein concentrate from another plant, including wheat, grains (including, quinoa, barley, bulgur, farro and kasha), pulse (including, lentils, dry beans, dry broad beans, dry peas, chickpeas, cow peas, pigeon peas, Bambara beans, vetches, lupins, pulses nes), cereals (including, pearl millet, proso millet, sorghum, oats, rye, left triticale, finger millet, fonio, foxtail millet, kodo millet, Japanese millet, Job's Tears), pseudograins (including, amaranth, breadnut, buckwheat, aria, cockscomb, oilseed goosefoot, kaniwa, wattleseed) legumes (including, alfalfa, clover, peas, beans, lupins, mesquite, carob, soybeans, peanuts, tamarind), rice, mung beans and corn.

In another embodiment, the meat substitute containing a seaweed protein concentrate created by a manufacturing process disclosed herein has a tensile strength that is no more than 1%, no more than 2%, no more than 3%, no more than 4%, no more than 5%, no more than 6%, no more than 7%, no more than 8%, no more than 9%, no more than 10%, no more than 11%, no more than 12%, no more than 13%, no more than 14%, no more than 15%, no more than 16%, no more than 17%, no more than 18%, no more than 19%, no more than 20%, no more than 21%, no more than 22%, no more than 23%, no more than 24%, no more than 25%, no more than 26%, no more than 27%, no more than 28%, no more than 29%, no more than 30%, no more than 31%, no more than 32%, no more than 33%, no more than 34%, no more than 35%, no more than 36%, no more than 37%, no more than 38%, no more than 39%, no more than 40%, no more than 41%, no more than 42%, no more than 43%, no more than 44%, no more than 45%, no more than 46%, no more than 47%, no more than 48%, no more than 49%, no more than 50%, no more than 51%, no more than 52%, no more than 53%, no more than 54%, no more than 55%, no more than 56%, no more than 57%, no more than 58%, no more than 59%, no more than 60%, no more than 61%, no more than 62%, no more than 63%, no more than 64%, no more than 65%, no more than 66%, no more than 67%, no more than 68%, no more than 69%, no more than 70%, no more than 71%, no more than 72%, no more than 73%, no more than 74%, no more than 75%, no more than 76%, no more than 77%, no more than 78%, no more than 79%, no more than 80%, no more than 81%, no more than 82%, no more than 83%, no more than 84%, no more than 85%, no more than 86%, no more than 87%, no more than 88%, no more than 89%, no more than 90%, no more than 91%, no more than 92%, no more than 93%, no more than 94%, no more than 95%, no more than 96%, no more than 97%, no more than 98%, no more than 99% or no more than 100% greater than a meat substitute containing a protein concentrate from another plant, including wheat, grains (including, quinoa, barley, bulgur, farro and kasha), pulse (including, lentils, dry beans, dry broad beans, dry peas, chickpeas, cow peas, pigeon peas, Bambara beans, vetches, lupins, pulses nes), cereals (including, pearl millet, proso millet, sorghum, oats, rye, teff, triticale, finger millet, fonio, foxtail millet, kodo millet, Japanese millet, Job's Tears), pseudograins (including, amaranth, breadnut, buckwheat, chia, cockscomb, pitseed goosefoot, kaniwa, wattleseed) legumes (including, alfalfa, clover, peas, beans, lupins, mesquite, carob, soybeans, peanuts, tamarind), rice, mung beans and Win.

In a further embodiment, a method of making a plant-based meat substitute product, including a plant-based ground meat substitute product can include (a) heating a plant-based meat substitute product to a temperature ranging from 150.degree. F. to 250.degree. F. or to a temperature of about 150.degree. F, about 160.degree. F, about 170.degree. F, about 180.degree. F, about 190.degree. F, about 200.degree. F, about 210.degree. F, about 220.degree. F, about 230.degree. F, about 240.degree. F, about 250.degree. F, about 260.degree. F, about 270.degree. F, about 280.degree. F, about 290.degree. F, about 300.degree. F, about 310.degree. F, about 320.degree. F, about 330.degree. F, about 340.degree. F, about 350.degree. F, about 360.degree. F, about 370.degree. F, about 380.degree. F, about 390.degree. F, about 400.degree. F, about 410.degree. F, about 420.degree. F, about 430.degree. F, about 440.degree. F, about 450.degree. F, about 460.degree. F, about 470.degree. F, about 480.degree. F, about 490.degree. F or about 500.degree. F; wherein the plant-based meat substitute product includes a meat substitute and one or more of the following a fat, the fat optionally containing a flavoring agent and/or an concentrated plant protein; a carbohydrate, including a carbohydrate-based gel, an optional edible fibrous component, an optional binding agent, a heme containing protein or an iron ion and/or an iron salt, a pH adjusting agent, an antioxidant and one or more optional flavoring agents to make a plant-based meat substitute product that after cooking tastes like a natural animal meat, such as a ground meat burger, wherein the meat comes from a cow.

In an embodiment, the plant-based meat substitute product created by a manufacturing process disclosed herein has a moisture content of at least about 30%. In some embodiments, the plant-based meat substitute product provided herein created by a manufacturing process disclosed herein comprise a moisture content of between about 30% and about 70%, between about 40% and about 60%, between about 33% and about 45%, between about 40% and about 50% between about 30% and about 60%, between about 50% and about 70%, or between about 55% and about 65% by weight. In another embodiment, the plant-based meat substitute product has a moisture content of between about 50% and about 85%, between about 60% and about 80%, between about 50% and about 70%, between about 70% and about 80%, between about 75% and about 85%, or between about 65% and about 90% by weight.

In another embodiment, the plant-based meat substitute product or other product created by a manufacturing process disclosed herein has a moisture content that is at least 1%, at least 2%, at least 3%, at least 4%, at least 5%, at least 6%, at least 7%, at least 8%, at least 9%, at least 10%, at least 11%, at least 12%, at least 13%, at least 14%, at least 15%, at least 16%, at least 17%, at least 18%, at least 19%, at least 20%, at least 21%, at least 22%, at least 23%, at least 24%, at least 25%, at least 26%, at least 27%, at least 28%, at least 29%, at least 30%, at least 31%, at least 32%, at least 33%, at least 34%, at least 35%, at least 36%, at least 37%, at least 38%, at least 39%, at least 40%, at least 41%, at least 42%, at least 43%, at least 44%, at least 45%, at least 46%, at least 47%, at least 48%, at least 49%, at least 50%, at least 51%, at least 52%, at least 53%, at least 54%, at least 55%, at least 56%, at least 57%, at least 58%, at least 59%, at least 60%, at least 61%, at least 62%, at least 63%, at least 64%, at least 65%, at least 66%, at least 67%, at least 68%, at least 69%, at least 70%, at least 71%, at least 72%, at least 73%, at least 74%, at least 75%, at least 76%, at least 77%, at least 78%, at least 79%, at least 80%, at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99% or at least 100% by weight.

In another embodiment, the plant-based meat substitute product or other product created by a manufacturing process disclosed herein has a moisture content that is about 1%, about 2%, about 3%, about 4%, about 5%, about 6%, about 7%, about 8%, about 9%, about 10%, about 11%, about 12%, about 13%, about 14%, about 15%, about 16%, about 17%, about 18%, about 19%, about 20%, about 21%, about 22%, about 23%, about 24%, about 25%, about 26%, about 27%, about 28%, about 29%, about 30%, about 31%, about 32%, about 33%, about 34%, about 35%, about 36%, about 37%, about 38%, about 39%, about 40%, about 41%, about 42%, about 43%, about 44%, about 45%, about 46%, about 47%, about 48%, about 49%, about 50%, about 51%, about 52%, about 53%, about 54%, about 55%, about 56%, about 57%, about 58%, about 59%, about 60%, about 61%, about 62%, about 63%, about 64%, about 65%, about 66%, about 67%, about 68%, about 69%, about 70%, about 71%, about 72%, about 73%, about 74%, about 75%, about 76%, about 77%, about 78%, about 79%, about 80%, about 81%, about 82%, about 83%, about 84%, about 85%, about 86%, about 87%, about 88%, about 89%, about 90%, about 91%, about 92%, about 93%, about 94%, about 95%, about 96%, about 97%, about 98%, about 99% or about 100% by weight.

In another embodiment, the plant-based meat substitute product or other product created by a manufacturing process disclosed herein has a moisture content that is no more than 1%, no more than 2%, no more than 3%, no more than 4%, no more than 5%, no more than 6%, no more than 7%, no more than 8%, no more than 9%, no more than 10%, no more than 11%, no more than 12%, no more than 13%, no more than 14%, no more than 15%, no more than 16%, no more than 17%, no more than 18%, no more than 19%, no more than 20%, no more than 21%, no more than 22%, no more than 23%, no more than 24%, no more than 25%, no more than 26%, no more than 27%, no more than 28%, no more than 29%, no more than 30%, no more than 31%, no more than 32%, no more than 33%, no more than 34%, no more than 35%, no more than 36%, no more than 37%, no more than 38%, no more than 39%, no more than 40%, no more than 41%, no more than 42%, no more than 43%, no more than 44%, no more than 45%, no more than 46%, no more than 47%, no more than 48%, no more than 49%, no more than 50%, no more than 51%, no more than 52%, no more than 53%, no more than 54%, no more than 55%, no more than 56%, no more than 57%, no more than 58%, no more than 59%, no more than 60%, no more than 61%, no more than 62%, no more than 63%, no more than 64%, no more than 65%, no more than 66%, no more than 67%, no more than 68%, no more than 69%, no more than 70%, no more than 71%, no more than 72%, no more than 73%, no more than 74%, no more than 75%, no more than 76%, no more than 77%, no more than 78%, no more than 79%, no more than 80%, no more than 81%, no more than 82%, no more than 83%, no more than 84%, no more than 85%, no more than 86%, no more than 87%, no more than 88%, no more than 89%, no more than 90%, no more than 91%, no more than 92%, no more than 93%, no more than 94%, no more than 95%, no more than 96%, no more than 97%, no more than 98%, no more than 99% or no more than 100% by weight.

### EXAMPLES

The following non-limiting examples are provided for illustrative purposes only in order to facilitate a more complete understanding of representative embodiments now contemplated. These examples are intended to be a mere subset of all possible contexts in which the components of the formulation may be combined. Thus, these examples should not be construed to limit any of the embodiments described in the present specification, including those pertaining to the type and amounts of components of the formulation and/or methods and uses thereof

### Example 1

Small-Scale Protein Extraction

In this example, protein was extracted from seaweed on a small scale. The starting material was fresh Gracilaria seaweed. A weight of 100 grams of fresh material was raised to 200 grams with ice and then raised to 1500 grams with water. The suspension was ground at approximately 30 second intervals with a Vitamix blender. The suspension was subjected to three grinding intervals with a two-minute wait time in between grinding. No large particles were visible after this step.

Next, solids were sieved out using a two-sieve system followed with a fine mesh cloth. Acetic acid was added to the sieved liquid to drop the pH to 3.9. Phosphoric acid was then used to lower the pH to about 2.5. At this step, protein precipitated out of solution.

Centrifugation was used in the next step. Specifically, the precipitated protein was separated using centrifugation at 3500 rpm for 3 minutes. The protein portion was then rinsed twice by adding tap water to the tube, mixing well, and centrifuging again (3500 rpm for 3 minutes).

The final protein paste was then used in a meat substitute burger recipe. First, a base recipe for a meat substitute burger was created as follows: 63.3 g of water was added to 17 g textured vegetable protein (TVP, Anthony's textured vegetable protein) and the TVP allowed to absorb the water. Next, a slurry mixture of 6.75 g canola oil (Mazola) and 2.25 g methylcellulose high viscosity (Modernist Pantry) was created and added to the hydrated textured vegetable protein. Lastly, 11.3 g of coconut oil (Nutiva) was added and mixed. All of the ingredients were mixed together by hand and formed into a 113 g (4 oz) patty, Next, 12.4 g of the protein concentrate paste generated above was added and mixed to integrate the protein throughout the patty, This resulted in a pink patty which resembled a raw beef patty. The patty was then placed on a wire rack in the oven and cooked at 425F for 10 minutes. The patty turned brown on the outside and remained slightly pink on the inside. A taste test following cooking demonstrated a very slight detectable flavor from the seaweed protein concentrate.

### Example 2

### Mid-Scale Protein Extraction

In this example, protein was extracted from seaweed on a larger scale and volume than was feasible at the laboratory bench scale. The starting material was fresh Gracilaria. As in Example 1, a starting weight of 100 grams fresh material was raised to 200 grams with ice cubes and then raised to 1500 grams with water and was ground in a Vitamix blender following the same protocol as Example 1. The blended suspension was then added to a five-gallon bucket. The weighing and grinding steps were then repeated until the batch reached a volume of about 15 liters.

Next, the material was separated into liquid and solid streams using a semi-continuous centrifuge (Basic Algae Centrifuge, Algae Centrifuge, Sacramento, CA). The pH of the liquid stream was then measured and adjusted. Acetic acid was added to the liquid to drop the pH to about 3.9. Phosphoric acid was then used to lower the pH to about 2.5. At this step, protein precipitated out of solution.

Centrifugation was used in the next step. Specifically, the precipitated protein was separated using a semi-continuous centrifuge (Basic Algae Centrifuge, Algae Centrifuge, Sacramento, CA). The protein was then weighed and freeze dried to determine the yield.

This procedure was repeated using a starting weight of 20 grams of dried Porphyra (non) instead of 100 grams of fresh Gracilaria in each initial batch.

### Example 3

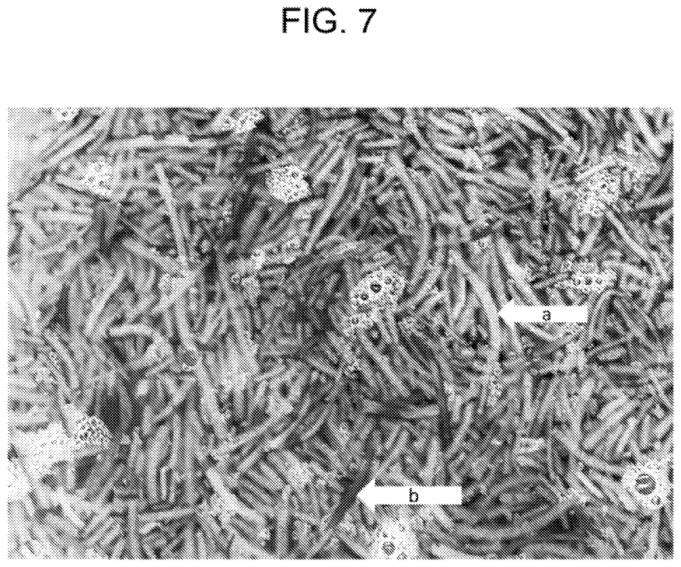

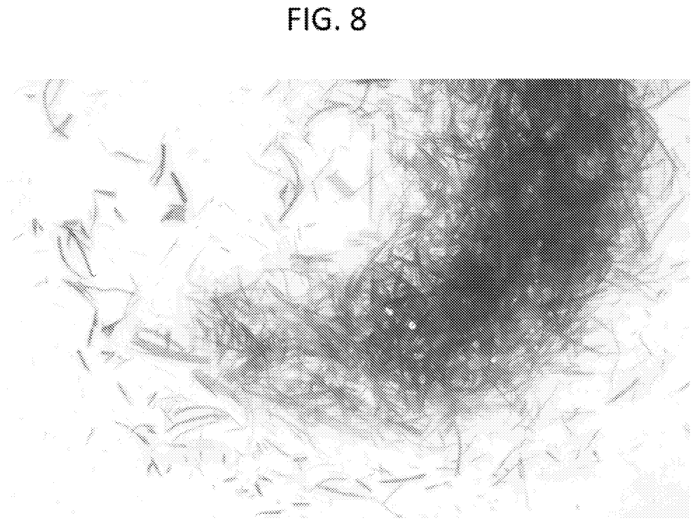

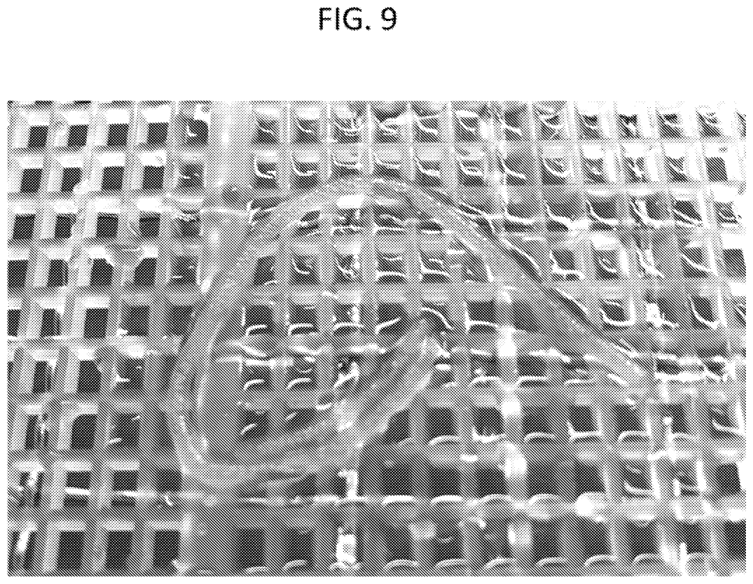

A dried seaweed (Gracilaria) was suspended in water at a ratio of 1:20 (seaweed: water w/w). Following suspension, acetic acid was added, followed by phosphoric acid to achieve a final pH of 2.5. The solubilized and acid treated seaweed was then heated for 30 minutes at a temperature in the range of 110° F.-180° F. to loosen and detach the outer layer of the seaweed thallus (the cortex, a reddish skin that contains the majority of the phycoerythrin protein) (FIG. 7), from the cylindrical inner core (the medulla, a colorless translucent tube that is rich in agar). FIG. 7 shows the partially delaminated pieces of seaweed during agitation, FIG. 7a. shows a fully delaminated piece of seaweed while FIG. 7b. indicates a piece of seaweed in which the outer cortex remains attached. The heated and resolubilized and acid treated seaweed was then subject to a low shear mixing for 2-15 minutes until the outer skin layer (FIG. 8 ) was observed to loosen or detach from the inner core material (FIG. 9). The outer skins were then separated from the inner core pieces by passing the mixture through a series of sieves that range from No. 25 (0.707 mm) to No. 14 (1.41 mm). The outer skins were then concentrated by centrifugation at 3000 g for between 2-10 minutes. The outer skins were resuspended in water at approximately 1:30 (seaweed: water v/v). The outer skins were mixed and centrifuged at 3000g for between 2-10 minutes to continue to separate the outer skins from the inner core material. This step was repeated to increase the purity of the fraction containing the protein-rich skins. The outer skins containing the protein concentrate were dried at a range of 95° F.-130° F. using an oven dryer.

### Example 4

### Pilot Scale Protein Extraction

Dried seaweed (Porphyra spp.) seaweed was ground using a hammer mill (Viking Electric Hammer Mill) fitted with a 0.065 inch screen and the material that passed through the screen was collected.

The particle size was analyzed using a Malvern Mastersizer 2000 with Hydro 2000MU (A). The particle size of the initial ground dried seaweed powder had a volume weighted mean of 511.7 um.

The collected ground seaweed was mixed at a ratio of 20 kg ground dried seaweed with 980 kg water (a 2% loading ratio by weight) in a 2000 L tank. The mixing speed was adjusted to allow for sufficient mixing and to minimize cavitation and the resultant bubble formation.

The mixture was then separated into a liquid phase and a solid phase using a decanting centrifuge (Centrisys CS10-4) with a bowl speed of approximately 4200 rpm at a rate of approximately 13 L/min. The liquid phase was collected and retained. The solid phase was discarded.

A food grade phosphoric acid was added to the collected liquid phase until the pH of the liquid phase had a pH of 2.5.

The liquid phase (now at pH 2.5) was then flash heated to a temperature of approximately 100° C. using a Pick direct steam injection industrial heater (Pick Heater SC2-3, Pick Heaters Inc.) with a residence time of the liquid in the heater of less than 30 seconds. Following the flash heating, the liquid was rapidly cooled by pumping the liquid into an agitated cooling jacketed vessel (50-gallon tank, Cherry Burrell). The liquid was cooled for approximately 60 minutes to a temperature of 30° C.

The combination of heat, low pH and then cooling resulted in the precipitation of soluble proteins from the liquid. These proteins were then separated out by centrifugation using a disk stack centrifuge (Alfa Laval: BTPX-205TGD-14) at a flow rate of 13 L/min and a discharge rate of 45 seconds.

Following disk stack centrifugation, the solids were collected and the pH was raised to 6.5 using food grade sodium hydroxide.

Next, water was added to the solids for a final solid composition that comprised about 10% dry solids and about 90% water.

The liquified solids were then spray dried using a spray drier with a diameter of 49 inches (APV Crepaco Inc.). The liquid solids were spray dried using an inlet temperature of 151° F. and an outlet temperature of 93° F.

Once the spray dried material was dry, it was collected, weighed, and the protein concentration was quantified using the AOAC Method 992.23 (1998) using Dumas Combustion using an Elementar Vario-Max CN Analyzer and a conversion factor of 6.25. Over the course of three runs with the above disclosed method of this Example 4, the average protein concentration of the spray dried solid was 68.4%+/−2.83%

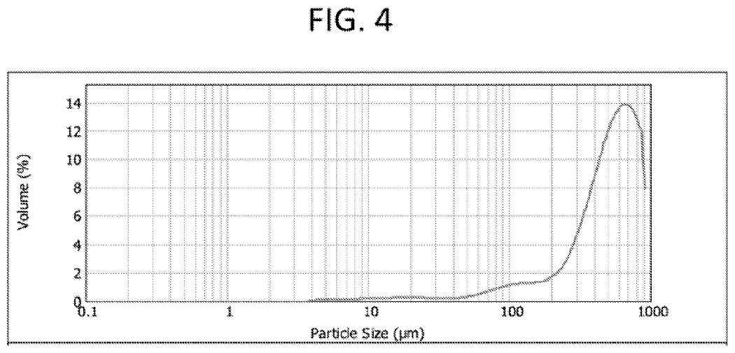

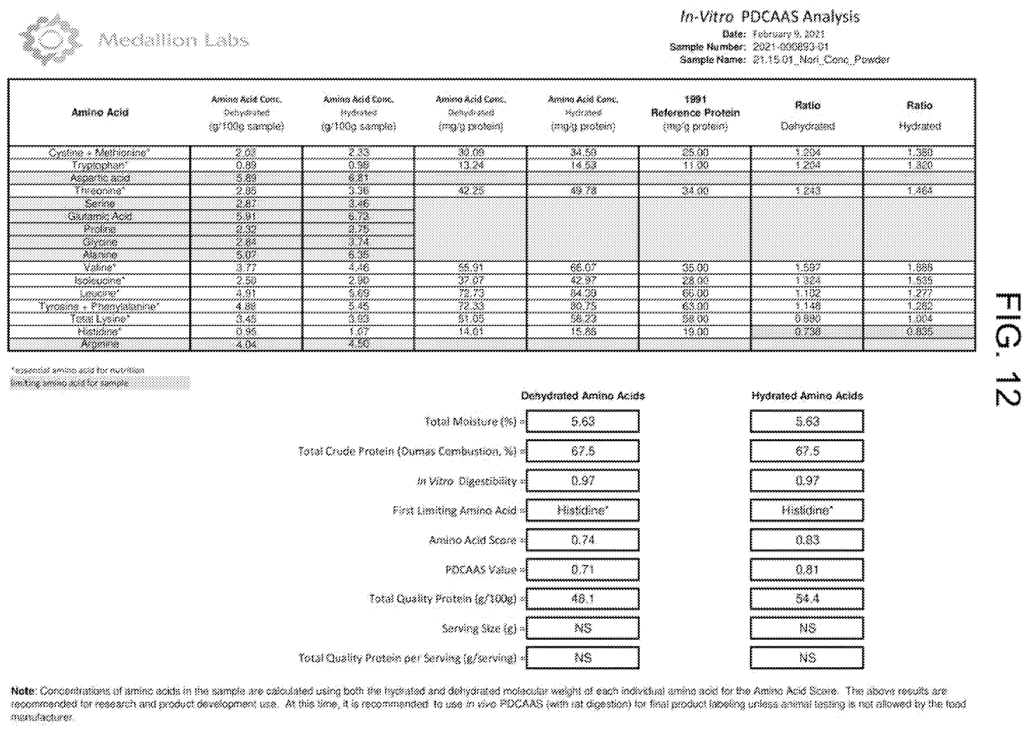

The particle size of the final spray dried protein concentrate had a volume weighted mean of 19.76 um as depicted in FIG. 4. A 100 g sample was sent off for in-vitro PDCAAS (Protein Digestibility Corrected Amino Acid Score) analysis by Medallion Laboratories (See FIG. 12) and resulted in an in-vitro digestibility score of 97%, and a PDCAAS score of 0.71 for dehydrated amino acids with histidine as the limiting essential amino acid.

The final spray dried protein concentrate was then used in a meat substitute burger recipe. First, a base recipe for a meat substitute burger was created as follows: 190 g of water was added to 51 g textured vegetable protein (TVP, Anthony's textured vegetable protein) and the TVP allowed to absorb the water. Next, a slurry mixture was created consisting of 20.25 g canola oil (Mazola) and 6.75 g methylcellulose high viscosity (Modernist Pantry) and the slurry was added to the hydrated textured vegetable protein. Lastly, 33.9 g of coconut oil (Nutiva) was added and mixed. An of the ingredients were mixed together by hand and a 60 g patty was separated out. Next, 0.6 g of the spray dried protein concentrate was mixed by hand into the patty until it was well integrated throughout the patty. It resulted in a pink patty which resembled a raw beef patty. The patty was then placed on a wire rack in the oven and cooked at 425 F for approximately 5 minutes. The patty turned brown on the outside and remained slightly pink on the inside. A taste test demonstrated no detectable flavor from the seaweed protein concentrate.

### Example 5

### Pilot Scale Protein Extraction (Ethanol Wash)

Dried seaweed (Porphyra spp.) seaweed was ground using a hammer mill (Viking Electric Hammer Mill) fitted with a 0.065-inch screen and the material that passed through the screen was collected.

The collected ground seaweed was mixed at a ratio of 10 kg ground dried seaweed with 490 kg water (a 2% loading ratio by weight) in a 2000 L tank. The mixing speed was adjusted to allow for sufficient mixing and to minimize cavitation and the resultant bubble formation.

The mixture was then separated into a liquid phase and a solid phase using a decanting centrifuge (Centrisys CS10-4) with a bowl speed of approximately 4200 rpm at a rate of approximately 13 L/min. The liquid phase was collected and retained. The solid phase was discarded.

A food grade phosphoric acid was added to the collected liquid phase until the pH of the liquid phase had a pH of 3.2.

The liquid phase (now at pH 2.5) was then flash heated to a temperature of approximately 100° C. using a Pick direct steam injection industrial heater (Pick Heater SC2-3, Pick Heaters Inc.) with a residence time of the liquid in the pick heater of less than 30 seconds. Following the flash heating, the liquid was rapidly cooled by pumping the liquid into an agitated cooling jacketed vessel (50-gallon tank, Cherry Burrell). The liquid was cooled for approximately 60 minutes to a temperature of 30° C.

The combination of heat, low pH and then cooling resulted in the precipitation of soluble proteins from the liquid. These proteins were then separated out by centrifugation using a vertical tubular centrifuge (VTC) at a flow rate of 13 L/min and a discharge rate of 45 seconds.

Next, 95% ethanol (ETOH) was added to the solids at a twenty times solid to ETOH volume ratio. The solution was mixed thoroughly until the solid was resuspended.

The ETOH/solid solution were then put into a VTC. A liquid fraction which was green in color was removed and the solids were resuspended in cold water at a ratio of twenty times water to one times solids.

The resuspended solids are then put into a VTC, the solids collected and resuspended in cold water at a ratio of twenty times water to one times solids and then put into a VTC one more time.

Following the final VTC, the solids were collected and the pH was raised to 6.5 using food grade sodium hydroxide.

The liquified solids were then spray dried using a 49-inch diameter spray drier (APV Crepaco Inc.). The liquid solids were spray dried using an inlet temperature of 151° F. and an outlet temperature of 93° F.

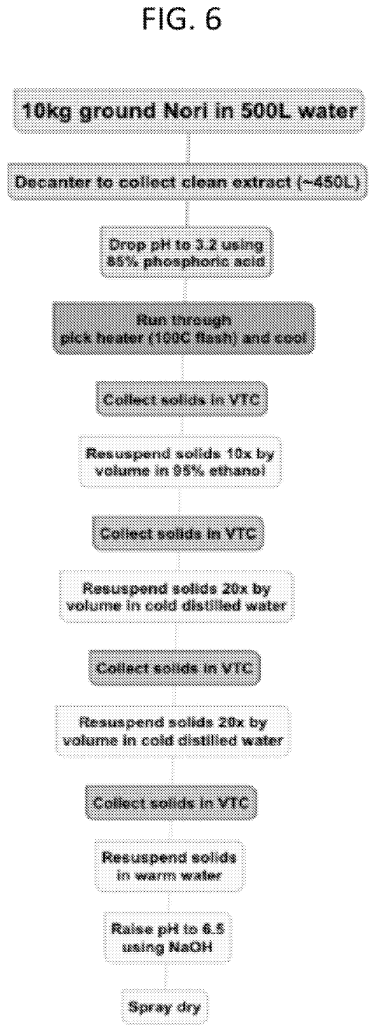

A flow chart of the method disclosed in this Example 5 is set forth in FIG. 6.

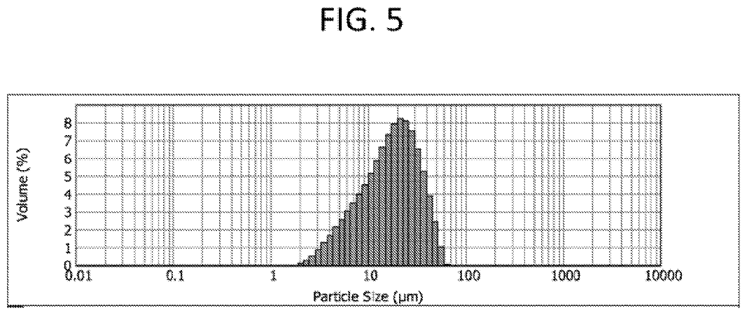

The final protein concentration of the spray dried solids was 79.8% as determined by nitrogen by combustion and a multiplier of 6.25 as disclosed in FIG. 5.

The above non-limiting examples are provided for illustrative purposes only in order to facilitate a more complete understanding of the disclosed subject matter. These examples should not be construed to limit any of the embodiments described in the present specification, including those pertaining to the isolation of protein from seaweed.

In closing, it is to be understood that although aspects of the present specification are highlighted by referring to specific embodiments, one skilled in the art will readily appreciate that these disclosed embodiments are only illustrative of the principles of the subject matter disclosed herein. Therefore, it should be understood that the disclosed subject matter is in no way limited to a particular compound, composition, article, apparatus, methodology, protocol, and/or reagent, etc., described herein, unless expressly stated as such. In addition, those of ordinary skill in the art will recognize that certain changes, modifications, permutations, alterations, additions, subtractions and sub-combinations thereof can be made in accordance with the teachings herein without departing from the spirit of the present specification. It is therefore intended that the following appended claims and claims hereafter introduced are interpreted to include all such changes, modifications, permutations, alterations, additions, subtractions and sub-combinations as are within their true spirit and scope.

Certain embodiments of the present invention are described herein, including the best mode known to the inventors for carrying out the invention. Of course, variations on these described embodiments will become apparent to those of ordinary skill in the art upon reading the foregoing description. The inventor expects skilled artisans to employ such variations as appropriate, and the inventors intend for the present invention to be practiced otherwise than specifically described herein. Accordingly, this invention includes all modifications and equivalents of the subject matter recited in the claims appended hereto as permitted by applicable law. Moreover, any combination of the above-described embodiments in all possible variations thereof is encompassed by the invention unless otherwise indicated herein or otherwise clearly contradicted by context.

Groupings of alternative embodiments, elements, or steps of the present invention are not to be construed as limitations. Each group member may be referred to and claimed individually or in any combination with other group members disclosed herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

Unless otherwise indicated, all numbers expressing a characteristic, item, quantity, parameter, property, term, and so forth used in the present specification and claims are to be understood as being modified in all instances by the term “about.” As used herein, the term “about” means that the characteristic, item, quantity, parameter, property, or term so qualified encompasses a range of plus or minus ten percent above and below the value of the stated characteristic, item, quantity, parameter, property, or term. Accordingly, unless indicated to the contrary, the numerical parameters set forth in the specification and attached claims are approximations that may vary. For instance, as mass spectrometry instruments can vary slightly in determining the mass of a given analyte, the term “about” in the context of the mass of an ion or the mass/charge ratio of an ion refers to +/−0.50 atomic mass unit. At the very least, and not as an attempt to limit the application of the doctrine of equivalents to the scope of the claims, each numerical indication should at least be construed in light of the number of reported significant digits and by applying ordinary rounding techniques.

Use of the terms “may” or “can” in reference to an embodiment or aspect of an embodiment also carries with it the alternative meaning of “may not” or “cannot.” As such, if the present specification discloses that an embodiment or an aspect of an embodiment may be or can be included as part of the inventive subject matter, then the negative limitation or exclusionary proviso is also explicitly meant, meaning that an embodiment or an aspect of an embodiment may not be or cannot be included as part of the inventive subject matter. In a similar manner, use of the term “optionally” in reference to an embodiment or aspect of an embodiment means that such embodiment or aspect of the embodiment may be included as part of the inventive subject matter or may not be included as part of the inventive subject matter. Whether such a negative limitation or exclusionary proviso applies will be based on whether the negative limitation or exclusionary proviso is recited in the claimed subject matter. Further, the use of the terms “include,” “includes” and “including” means include, includes and or including as well as include, includes and including, but not limited to.

Notwithstanding that the numerical ranges and values setting forth the broad scope of the invention are approximations, the numerical ranges and values set forth in the specific examples are reported as precisely as possible. Any numerical range or value, however, inherently contains certain errors necessarily resulting from the standard deviation found in their respective testing measurements.

Recitation of numerical ranges of values herein is merely intended to serve as a shorthand method of referring individually to each separate numerical value falling within the range. Unless otherwise indicated herein, each individual value of a numerical range is incorporated into the present specification as if it were individually recited herein.

The terms “a,” “an,” “the” and similar references used in the context of describing the present invention (especially in the context of the following claims) are to be construed to cover both the singular and the plural, unless otherwise indicated herein or clearly contradicted by context. Further, ordinal indicators—such as “first,” “second,” “third,” etc.—for identified elements are used to distinguish between the elements, and do not indicate or imply a required or limited number of such elements, and do not indicate a particular position or order of such elements unless otherwise specifically stated. All methods described herein can be performed in any suitable order unless otherwise indicated herein or otherwise clearly contradicted by context. The use of any and all examples, or exemplary language (e.g., “such as”) provided herein is intended merely to better illuminate the present invention and does not pose a limitation on the scope of the invention otherwise claimed. No language in the present specification should be construed as indicating any non-claimed element essential to the practice of the invention.

When used in the claims, whether as filed or added per amendment, the open-ended transitional term “comprising” (and equivalent open-ended transitional phrases thereof like including, containing and having) encompasses all the expressly recited elements, limitations, steps and/or features alone or in combination with unrecited subject matter; the named elements, limitations and/or features are essential, but other unnamed elements, limitations and/or features may be added and still form a construct within the scope of the claim. Specific embodiments disclosed herein may be further limited in the claims using the closed-ended transitional phrases “consisting of” or “consisting essentially of” in lieu of or as an amended for “comprising.” When used in the claims, whether as filed or added per amendment, the closed-ended transitional phrase “consisting of” excludes any element, limitation, step, or feature not expressly recited in the claims. The closed-ended transitional phrase “consisting essentially of” limits the scope of a claim to the expressly recited elements, limitations, steps and/or features and any other elements, limitations, steps and/or features that do not materially affect the basic and novel characteristic(s) of the claimed subject matter. Thus, the meaning of the open-ended transitional phrase “comprising” is being defined as encompassing all the specifically recited elements, limitations, steps and/or features as well as any optional, additional unspecified ones. The meaning of the closed-ended transitional phrase “consisting of” is being defined as only including those elements, limitations, steps and/or features specifically recited in the claim whereas the meaning of the closed-ended transitional phrase “consisting essentially of” is being defined as only including those elements, limitations, steps and/or features specifically recited in the claim and those elements, limitations, steps and/or features that do not materially affect the basic and novel characteristic(s) of the claimed subject matter. Therefore, the open-ended transitional phrase “comprising” (and equivalent open-ended transitional phrases thereof) includes within its meaning, as a limiting case, claimed subject matter specified by the closed-ended transitional phrases “consisting of” or “consisting essentially of.” As such embodiments described herein or so claimed with the phrase “comprising” are expressly or inherently unambiguously described, enabled and supported herein for the phrases “consisting essentially of” and “consisting of.”

All patents, patent publications, and other publications referenced and identified in the present specification are individually and expressly incorporated herein by reference in their entirety for the purpose of describing and disclosing, for example, the compositions and methodologies described in such publications that might be used in connection with the present invention. These publications are provided solely for their disclosure prior to the filing date of the present application. Nothing in this regard should be construed as an admission that the inventors are not entitled to antedate such disclosure by virtue of prior invention or for any other reason. All statements as to the date or representation as to the contents of these documents is based on the information available to the applicants and does not constitute any admission as to the correctness of the dates or contents of these documents.

Lastly, the terminology used herein is for the purpose of describing particular embodiments only and is not intended to limit the scope of the present invention, which is defined solely by the claims. Accordingly, the present invention is not limited to that precisely as shown and described.

1. A method of producing a meat substitute using a seaweed protein concentrate, the method comprising the steps of:
a. reducing the size of a starting material comprising seaweed pieces;
b. extracting seaweed protein by suspension of suspending the seaweed pieces in an aqueous solution;
c. separating and removing insoluble fraction from the aqueous solution;
d. adjusting the pH of the aqueous solution to precipitate a seaweed protein concentrate thereby forming a precipitated seaweed protein concentrate;
e. separating the precipitated seaweed protein concentrate;
f. drying the precipitated seaweed protein concentrate to form a dry seaweed protein concentrate; and
g. Integrating the seaweed protein concentrate into a meat substitute product to enhance sensory and/or functional attributes of the meat substitute product.

2. The method of claim 1, wherein the starting material is fresh seaweed.

3. The method of claim 1, wherein the starting material is dried seaweed.

4. The method of claim 1, wherein the step of extraction (b) further comprises a step of homogenization to reduce particle size.

5. The method of claim 1, wherein the step of extraction (b) further comprises a step of photobleaching.

6. The method of claim 1, wherein the step of extraction (b) further comprises at least one of enzymatic digestion, high pressure processing, and sonication followed by ammonium sulphate saturation.

7. (canceled)

8. The method of claim 1, wherein the starting material is at least one of a red seaweed, a brown seaweed and a green seaweed.

9. The method of claim 8, wherein the red seaweed is at least one of Gracilaria, Porphyra, Pyropia, Kappaphycus, Eucheuma and Palmaria.

10. The method of claim 8, wherein the brown seaweed is at least one of Undaria, Alaria, Laminaria, Sargassum and Saccharina.

11-15. (canceled)

16. The method of claim 1, wherein the step of extraction (b) further comprises a step of adjusting the pH to 8-10.

17. The method of claim 1, wherein the step of extraction (b) further comprises a step of heating the solution to about 60° C.

18. The method of claim 1, wherein the step of precipitation comprises at least one of sedimentation, centrifugation, filtration and column chromatography.

19. (canceled)

20. A method of producing a protein concentrate from seaweed with a wafer-like structure, the method comprising a step precipitating seaweed protein from solution at a pH of about pH 2.5 and freezing the seaweed protein concentrate.

21. A method of producing protein concentrate from seaweed with a fibrous structure, the method comprising neutralizing the pH of a seaweed protein isolate and freezing the seaweed protein concentrate.

22. A method of producing a protein concentrate from a starting material comprising seaweed pieces, the method comprising the steps of:
a) if required, reducing size of the seaweed pieces;
b) suspending the seaweed pieces in an acidic aqueous solution;
c) heating the solution containing the suspended pieces of the seaweed;
d) agitating the suspended pieces of the seaweed;
e) separating one or more insoluble seaweed fractions from the aqueous solution; and,
f) drying one or more insoluble seaweed fractions comprising a protein concentrate to form a dry protein concentrate.

23. The method of claim 22 wherein the starting material is fresh seaweed.

24. The method of claim 22, wherein the starting material is dried seaweed.

25. The method of claim 22, wherein the pH of one or more insoluble seaweed fractions of step (e) is adjusted to a neutral or alkaline pH.

26. The method of claim 22, wherein the step of agitation (d) further comprises at least one of acid hydrolysis, enzymatic digestion, high pressure processing and sonication.

27. The method of claim 22, wherein the starting material is at least one of a red seaweed, a brown seaweed and a green seaweed.

28. The method of claim 22, wherein the red seaweed is at least one of Gracilaria, Porphyra, Pyropia, Kappaphycus, Eucheuma and Palmaria.

29. The method of claim 22, wherein the brown seaweed is at least one of Undaria, Alaria, Laminaria, Sargassum and Saccharina.

30-34. (canceled)

35. The method of claim 22, wherein the step of heating the solution (c) further comprises a step of heating the solution to about 60° C., to about to about 70° C., to about 75° C., to about 80° C., to about 85° C., or to about 90° C.

36. The method of claim 22, wherein the step of separation (e) comprises at least one of sedimentation, use of a sieve, centrifugation, filtration and column chromatography.

37-40. (canceled)

41. The method of claim 22, wherein the different one or more insoluble fractions comprise two insoluble fractions.

42. The method of claim 41, wherein one of the two insoluble fractions comprises a protein concentrate and the other insoluble fraction comprises a carbohydrate.

43-45. (canceled)

46. The method of claim 22, wherein prior to the drying (f), one or more of the protein concentrate and an insoluble fraction is subjected to an enzymatic digestion.

47-50. (canceled)

51. The method of claim 46, wherein the enzymatic digestion increases the functionality for use of one or more of the protein concentrate and an insoluble fraction.

52. The method of claim 22, wherein both the protein concentrate and an insoluble fraction are dried.

53-65. (canceled)

66. The method of claim 1, wherein the meat substitute product changes color upon heating.

67. The method of claim 66, wherein the color change upon heating is a change in color from pinkish, reddish, or reddish-purple like color to a brownish color.

68. The method of claim 66, wherein the color change is only on the outside.

69. The method of claim 66, wherein the inside of the meat substitute product remains a pinkish, reddish or reddish-purple like color.

70. The method of claim 66, wherein the color change upon heating is a change in color to a brownish color on the outside and most or all of the inside of the meat substitute product.

71-73. (canceled)

74. The method of claim 1, wherein the protein fraction of the seaweed protein concentrate is at least 25% phycoerythrin.

75. The method of claim 1, wherein the polyphenol content of the seaweed protein concentrate is from about 0.1% to 10%.

76. (canceled)

77. The method of claim 1, wherein the protein concentrate of step (e) is rinsed to remove non-protein material.

78. The method of claim 1, wherein an additional step is conducted following completion of step (e), wherein the wet protein concentrate is rinsed in a solvent to remove non-protein material and further concentrate the protein in the protein concentrate.

79. The method of claim 78, wherein the solvent is an alcohol.

80. The method of claim 78, wherein the solvent is ethanol alcohol.

81. The method of claim 78, wherein the ethanol is at a concentration of 95%.

82. The method of claim 1, wherein an additional step is conducted following the step of claim 78, wherein the wet protein concentrate is rinsed in water to further purify the protein.

83. The method of claim 22, wherein one or more insoluble seaweed fractions of step (e) is rinsed to remove salts and/or small non-protein molecules.

84. (canceled)
